(19) United States
(12) Patent Application Publication
(10) Pub. No.: US 2015/0279009 A1
(43) Pub. Date: Oct. 1, 2015

(54) IMAGE PROCESSING APPARATUS, IMAGE PROCESSING METHOD, AND PROGRAM

(71) Applicant: SONY CORPORATION, TOKYO (JP)

(72) Inventors: JUNICHIRO ENOKI, KANAGAWA (JP); HISAKO SUGANO, KANAGAWA (JP)

(21) Appl. No.: 14/665,624

(22) Filed: Mar. 23, 2015

(30) Foreign Application Priority Data
Mar. 31, 2014 (JP) 2014-071215

(51) Int. Cl. G06T 5/00; H04N 9/64; G06T 1/00; H04N 5/232

(52) U.S. Cl. CPC G06T 5/003; H04N 5/23229; H04N 9/643; H04N 9/646; G06T 1/0007; G06T 5/002; G06T 2207/10004; G06T 2207/10016; G06T 2207/30221; G06T 2207/20182; G06T 2207/20201

(57) ABSTRACT

An image processing apparatus includes: an information acquisition unit configured to acquire information detected based on an activity performed along with capturing an image; an analysis unit configured to analyze an imaging situation of the image based on the information; and an image quality adjustment unit configured to perform, based on the analyzed imaging situation, image quality adjustment processing on image data corresponding to the imaging situation.

### CROSS REFERENCE TO RELATED APPLICATIONS

This application claims the benefit of Japanese Priority Patent Application JP 2014-071215 filed Mar. 31, 2014, the entire contents of which are incorporated herein by reference.

### BACKGROUND

The present technology relates to an image processing apparatus capable of performing image processing of image data, an image processing method, and a program.

An imaging terminal capable of performing imaging has been downsized and it is easy to capturing a moving image by a portable information terminal such as a smart phone. In recent years, there is a case where a user uses such a compact imaging terminal to capture a moving image or the like while the user himself or herself or a subject is playing sport or the like.

However, in some activities of the user himself or herself or the subject, it may be difficult to perform image processing according to an imaging situation. In view of this, Japanese Patent Application Laid-open No. 2013-197995 (hereinafter, referred to as Patent Document 1) has disclosed an image processing apparatus capable of tagging, when capturing moving image data of a vehicle, the moving image data as tags of start state, load noise, or the like and then using the tags to edit the image.

### SUMMARY

However, Patent Document 1 has not disclosed performing various types of image quality adjustment according to an imaging situation.

In view of the above-mentioned circumstances, it is desirable to provide an image processing apparatus capable of adjusting an image quality of image data according to an imaging situation, an image processing method, and a program.

According to an embodiment of the present technology, there is provided an image processing apparatus including an information acquisition unit, an analysis unit, and an image quality adjustment unit.

The information acquisition unit is configured to acquire information detected based on an activity performed along with capturing an image.

The analysis unit is configured to analyze an imaging situation of the image based on the information.

The image quality adjustment unit is configured to perform, based on the analyzed imaging situation, image quality adjustment processing on image data corresponding to the imaging situation.

With this configuration, the imaging situation is analyzed based on the information detected based on the activity performed along with imaging. The image quality adjustment processing according to the imaging situation becomes possible. The burden of the user to manually select the image quality adjustment processing is reduced.

The image quality adjustment processing may be processing of reducing deterioration in image quality estimated based on the analyzed imaging situation. With this, even in the imaging situation based on which the deterioration in image quality is estimated, suitable image quality adjustment processing becomes possible.

The information acquisition unit may be configured to acquire information detected based on an activity of a user during capturing an image. With this, even if the user himself or herself performs imaging while performing an activity such as a sport and it is difficult for the user to perform an image quality adjustment operation during imaging, suitable image quality adjustment processing becomes possible.

The information acquisition unit may be configured to acquire at least any of a pressure value, motion information, and position information based on an activity performed along with capturing an image. With this, it is possible to accurately specify the imaging situation. For example, the information acquisition unit may include a pressure information acquisition unit configured to acquire a pressure value received during imaging of at least either one of the user and a subject.

The analysis unit may be configured to judge, based on the pressure value, whether or not imaging is performed in water.

Alternatively, the information acquisition unit may include a motion information acquisition unit configured to acquire motion information of at least either one of the user and a subject.

The analysis unit may be configured to analyze, based on the motion information, the activity performed along with capturing the image.

In this case, the motion information acquisition unit may be configured to acquire a frequency of vibration as the motion information.

The analysis unit may be configured to conclude, if the frequency of the vibration is equal to or higher than a predetermined frequency, that the activity is an imaging situation with vibration.

The image quality adjustment unit may be configured to perform processing of correcting vibration of the image data based on the frequency of the vibration, if it is concluded that the activity is the imaging situation with vibration.

With this, it is possible to perform more suitable image quality adjustment processing according to the frequency of the vibration during imaging.

Alternatively, the information acquisition unit may include a position information acquisition unit configured to acquire position information during imaging of at least either one of the user and a subject.

The analysis unit may be configured to analyze, based on the position information, the activity performed along with capturing the image.

The analysis unit may be configured to analyze the imaging situation of the image based on the information acquired by the information acquisition unit and information extracted by analyzing a feature of a subject in the image. With this, it is possible to analyze the imaging situation with higher accuracy.

The image processing apparatus may further include an effect processing unit configured to perform, based on the analyzed imaging situation, effect processing on the image data corresponding to the imaging situation.

With this, the effect processing suitable for the imaging situation is automatically selected, and hence it is possible to reduce the burden on the user to select the effect processing.

The image processing apparatus may further include an audio adjustment unit configured to perform, based on the analyzed imaging situation, audio adjustment processing on audio data recorded along with capturing the image.

With this, audio adjustment processing suitable for the imaging situation is automatically selected, and hence it is possible to reduce the burden on the user to select audio adjustment processing.

The image processing apparatus may further include an image data recording unit configured to capture an image and record the image as image data. With this, the image quality adjustment processing can be performed using the recorded image data.

The image processing apparatus may further include a reproduction unit configured to reproduce the image data. With this, the image data whose image quality has been adjusted can be reproduced and checked.

The image processing apparatus may further include an image data acquisition unit configured to acquire the image data corresponding to the imaging situation. With this, the image quality adjustment processing can be performed using image data recorded in other apparatuses, image data stored in an image database over a network, and the like.

According to an embodiment of the present technology, there is provided an image processing method including acquiring information detected based on an activity performed along with capturing an image.

An imaging situation of the image is analyzed based on the information. Based on the analyzed imaging situation, image quality adjustment processing is performed on image data corresponding to the imaging situation.

According to an embodiment of the present technology, there is provided a program that causes an information processing apparatus to function as an information acquisition unit, an analysis unit, and an image quality adjustment unit.

The information acquisition unit is configured to acquire information detected based on an activity performed along with capturing an image.

The analysis unit is configured to analyze an imaging situation of the image based on the information.

The image quality adjustment unit is configured to perform, based on the analyzed imaging situation, image quality adjustment processing on image data corresponding to the imaging situation.

As described above, according to the embodiments of the present technology, it is possible to provide an image processing apparatus capable of adjusting an image quality of image data according to an imaging situation, an image processing method, and a program.

It should be noted that the effects described here are not necessarily limited and may be any of effects described in the present disclosure.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a hardware configuration of an image processing apparatus according to a first embodiment of the present technology;

FIG. 2 is a block diagram showing a functional configuration of the image processing apparatus;

FIG. 3 is a flowchart showing an operation of the image processing apparatus;

FIG. 4 is a schematic diagram showing an example of image data during diving, in which “A” shows image data before image quality adjustment and “B” shows image data after the image quality adjustment;

FIG. 5 is a schematic diagram showing an example of image data during snowboard, in which “A” shows image data before image quality adjustment and “B” shows image data after the image quality adjustment;

FIG. 6 is a schematic diagram showing an example of image data captured on the sea, in which “A” shows image data before image quality adjustment and “B” shows image data after the image quality adjustment;

FIG. 7 is a block diagram showing a functional configuration of an image processing apparatus according to a second embodiment of the present technology;

FIG. 8 is a flowchart showing an operation of the image processing apparatus;

FIG. 9 is a schematic diagram showing an example of image data obtained by performing effect processing on image data during cycling;

FIG. 10 is a schematic diagram showing an example of image data obtained by performing effect processing on image data during skydiving;

FIG. 11 is a block diagram showing a functional configuration of an image processing apparatus according to a third embodiment of the present technology;

FIG. 12 is a flowchart showing an operation of the image processing apparatus;

FIG. 13 is a block diagram showing a hardware configuration of an image processing apparatus according to a fourth embodiment of the present technology;

FIG. 14 is a block diagram showing a functional configuration of the image processing apparatus;

FIG. 15 is a flowchart showing an operation of the image processing apparatus;

FIG. 16 is a block diagram showing a functional configuration of a modified example of the image processing apparatus;

FIG. 17 is a block diagram showing a functional configuration of a modified example of the image processing apparatus;

FIG. 18 is a block diagram showing a hardware configuration of an image processing apparatus according to a fifth embodiment of the present technology;

FIG. 19 is a block diagram showing a functional configuration of the image processing apparatus;

FIG. 20 is a flowchart showing an operation of the image processing apparatus;

FIG. 21 is a block diagram showing a functional configuration of a modified example of the image processing apparatus; and

FIG. 22 is a block diagram showing a functional configuration of a modified example of the image processing apparatus.

### DETAILED DESCRIPTION OF EMBODIMENTS

Hereinafter, embodiments of the present technology will be described with reference to the drawings.

### First Embodiment

[Hardware Configuration of Image Processing Apparatus]

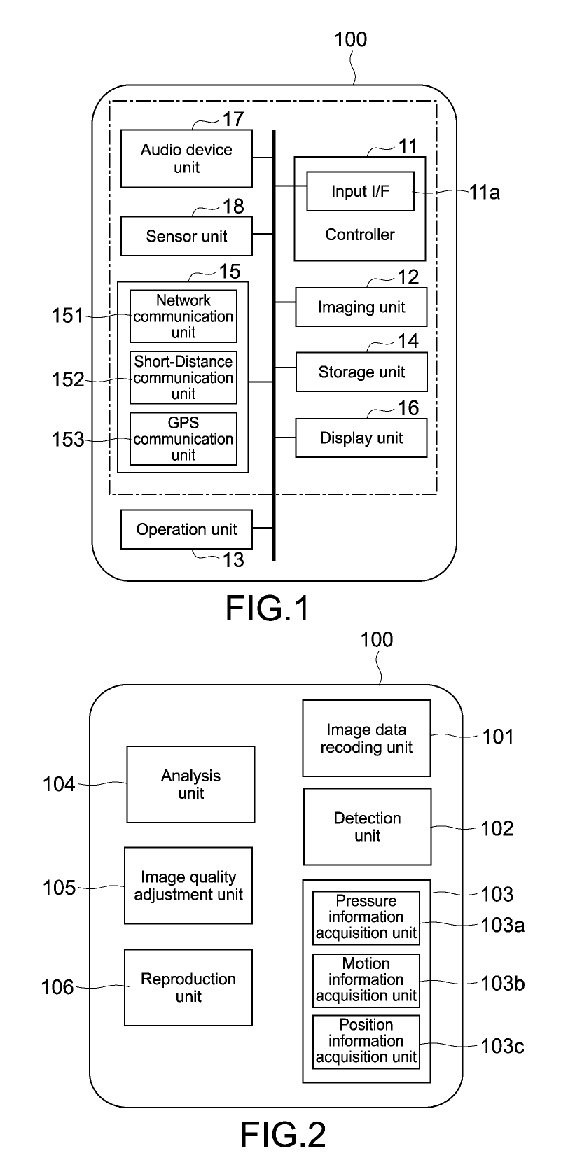

FIG. 1 is a block diagram showing a hardware configuration of an image processing apparatus 100 according to a first embodiment of the present technology. The image processing apparatus 100 includes a controller 11, an imaging unit 12, an operation unit 13, a storage unit 14, a communication unit 15, a display unit 16, an audio device unit 17, and a sensor unit 18. These units are connected to one another via a bus and configured to be capable of transferring data and transmitting and receiving a control signal. Note that, in this embodiment, it is assumed that image data is moving data.

The image processing apparatus 100 can be configured as an information processing apparatus in this embodiment. Specifically, the image processing apparatus 100 may be a portable information terminal such as a smartphone and a tablet terminal capable of capturing a moving image or may be a wearable apparatus such as a head-mounted display. Alternatively, the image processing apparatus 100 may be a moving image capturing apparatus capable of reproducing moving image data, and processing an image, and so on.

The image processing apparatus 100 may take various imaging states in addition to a state of being held by the user. For example, the image processing apparatus 100 may be worn by the user and capable of performing imaging. Alternatively, the image processing apparatus 100 may be attached to a bicycle, an automobile, or the like that the user is riding. That is, the image processing apparatus 100 may be capable of performing so-called onboard imaging. Alternatively, the image processing apparatus 100 may be capable of performing imaging in water. In this case, the image processing apparatus 100 may have a water-proof outer structure or the image processing apparatus 100 may be housed in a water-proof casing or the like such that the imaging in water can be performed.

The controller 11 includes a central processing unit (CPU) and comprehensively controls the units of the image processing apparatus 100. The controller 11 performs predetermined processing according to a control program stored in a read only memory (ROM) (not shown) or the storage unit 14. Note that the controller 11 includes an input I/F 11a into which information from the respective units is input.

The imaging unit 12 obtains image data from an optical image of a subject. Specifically, the imaging unit 12 may include an imaging optical system and an image sensor (not shown). The imaging optical system forms the optical image of the subject on an imaging plane of the image sensor. The imaging optical system is configured to be capable of adjusting a focal distance, a subject distance, a diaphragm, and the like such that a suitable image can be obtained according to an instruction from the controller 11. The image sensor is realized by a charge coupled device (CCD) sensor, a complementary metal semiconductor (CMOS) sensor, or the like. The image sensor converts the formed optical image into an electrical signal and obtains image data.

The operation unit 13 includes, for example, a touch panel, a hardware key such as a power-supply button, and an input device such as an operation dial. The operation unit 13 detects an input operation of the user and transmits the input operation to the controller 11. The operation unit 13 may be configured to be capable of, for example, starting and ending capturing of moving image data, selecting a mode such as a mode of image quality adjustment according to an imaging situation, and reproducing the moving image data.

The storage unit 14 can be configured by, for example, a semiconductor memory such as a flash memory, recoding media such as a magnetic disc, an optical disc, and a magneto-optical disk, and a recording and reproducing mechanism for the recoding media. The storage unit 14 stores image data as compressed image data and further stores image quality adjustment processing and the like which will be described later.

The communication unit 15 includes a network communication unit 151, a short-distance communication unit 152, and a global positioning system (GPS) reception unit 153. The network communication unit 151 is configured to be capable of communicating with a network through a wide-area communication system such as third generation (3G) and long term evolution (LTE), a wireless local area network (LAN) communication system such as Wi Fi (registered trademark), or a wired LAN communication system. The short-distance communication unit 152 is, for example, configured to be capable of communicating with a short-distance wireless communication system such as Bluetooth (registered trademark) and infrared. The GPS reception unit 153 obtains latitude/longitude information of the image processing apparatus 100.

The display unit 16 may be realized by a display element, for example, a liquid crystal display (LCD) or an organic electroluminescence (EL) panel and have a function as a finder. The display unit 16 may include a D/A conversion circuit and the like in addition to the display element.

The audio device unit 17 includes a microphone and a speaker.

The sensor unit 18 includes a pressure sensor, an acceleration sensor, and an angular velocity sensor. The pressure sensor can use a diaphragm type pressure sensor, for example. The acceleration sensor is, for example, configured to be capable of detecting acceleration in three-axis directions orthogonal to one another. The angular velocity sensor can be configured as a gyro sensor capable of detecting angular velocity around three axes orthogonal to one another. The sensor unit 18 may include a magnetic field sensor, for example, in addition to the above. Although not shown, the sensor unit 18 may include a circuit that converts signals or the like obtained by the respective sensors into electrical signals that can be used for processing of the controller 11.

In the image processing apparatus 100 having the above-mentioned hardware configuration, the controller 11, the imaging unit 12, the storage unit 14, the communication unit 15, the display unit 16, the audio device unit 17, and the sensor unit 18 that are shown in an alternate long and short dash line of FIG. 1 have a functional configuration as follows.

[Functional Configuration of Image Processing Apparatus]

FIG. 2 is a block diagram showing a functional configuration of the image processing apparatus 100. As shown in the figure, the image processing apparatus 100 includes an image data recording unit 101, a detection unit 102, an information acquisition unit 103, an analysis unit 104, an image quality adjustment unit 105, and a reproduction unit 106. As will be described below, the image processing apparatus 100 is configured to be capable of analyzing an imaging situation of an image based on information obtained by the information acquisition unit 103 and adjusting the image quality according to the imaging situation.

The image data recording unit 101 captures an image and records the image as the image data. The image data may be data compressed by an encoder. The image data recording unit 101 is realized by, for example, the imaging unit 12 and the storage unit 14.

The detection unit 102 detects information based on the activity of the user during capturing the image. The detection unit 102 is realized by, for example, the sensor unit 18 and the communication unit 15. Specifically, the detection unit 102 is capable of detecting signals relating to a pressure value (atmospheric pressure and hydraulic pressure), acceleration, angular velocity, and the like through the sensor unit 18 and detecting position information such as latitude/longitude information through the GPS reception unit 153. Alternatively, the short-distance communication unit 152 may obtain field intensity from a plurality of wireless LAN access points, such that the detection unit 102 can detect the position information based on a balance of the field intensity.

Although not particularly limited, examples of the activity of the user include sports such as diving, cycling, running, winter sports, marine sports, and skydiving and an event such as a wedding and a concert.

The information acquisition unit 103 acquires information detected based on an activity of the user during capturing an image. The information acquisition unit 103 is realized by, for example, the input I/F 11a of the controller 11. The information acquisition unit 103 acquires the information detected by the detection unit 102. The information acquisition unit 103 is capable of acquiring at least any of a pressure value, motion information, and position information based on an activity performed along with capturing an image. That is, the information acquisition unit 103 includes a pressure information acquisition unit 103a, a motion information acquisition unit 103b, and a position information acquisition unit 103c.

The pressure information acquisition unit 103a acquires a pressure value received during imaging of the user. Specifically, the pressure information acquisition unit 103a is capable of acquiring the pressure value detected by the detection unit 102.

The motion information acquisition unit 103b acquires motion information of the user. Specifically, the motion information acquisition unit 103b is capable of acquiring a signal relating to acceleration or angular velocity detected by the detection unit 102. The motion information acquisition unit 103b is also capable of acquiring, as the motion information, a frequency of vibration (hereinafter, also referred to as shake) based on the signal relating to the angular velocity.

The position information acquisition unit 103c acquires position information of the user. Specifically, the position information acquisition unit 103c is capable of acquiring position information detected by the detection unit 102.

The analysis unit 104 analyzes an imaging situation of an image based on the information acquired by the information acquisition unit 103. The analysis unit 104 is realized by, for example, the controller 11. The analysis unit 104 matches, for example, the information acquired by the information acquisition unit 103 and the moving image data recorded by the image data recording unit 101 with each other and analyzes the imaging situation of the moving image. An operation of the analysis unit 104 will be described later in detail.

The analysis unit 104 may analyze general imaging situations including, for example, an activity in water, an activity on snow, an activity on water, an activity in the air, and an indoor event, as the imaging situation of the moving image. The analysis unit 104 may analyze the imaging situation in more detail. Examples of the detailed imaging situation include diving classified as the activity in water, skiing classified as the activity on snow, windsurfing classified as the activity on water, and a wedding scene classified as the event.

The image quality adjustment unit 105 performs, based on the analyzed imaging situation, image quality adjustment processing on image data corresponding to the imaging situation. The image quality adjustment unit 105 is realized by, for example, the controller 11. The image quality adjustment unit 105 may, for example, perform image quality adjustment processing stored in association with the analyzed imaging situation. In this case, a correspondence relationship between the image quality adjustment processing and the imaging situation is stored in the storage unit 14. Alternatively, the image quality adjustment unit 105 may select image quality adjustment processing based on the imaging situation according to stored predetermined algorithm and perform the image quality adjustment processing. The image data subjected to the image quality adjustment processing by the image quality adjustment unit 105 is output to the reproduction unit 106.

The image quality adjustment processing may be processing of reducing deterioration in image quality estimated based on the analyzed imaging situation. Here, “being deteriorated in image quality” means being difficult to recognize an actual subject in an image. This state includes, for example, a state in which a shake occurs, a state in which hue of an image is different from original hue, and a state in which an image has a too high or low luminance. Specific examples of the image quality adjustment processing include hue correction processing, shake correction processing, luminance correction processing, gamma correction processing, and edge enhancement processing.

The hue correction processing is processing of correcting the hue of the image, for example, processing of adjusting a red green blue (RGB)-gain. The shake correction processing is so-called electronic shake correction processing. The shake correction processing is processing of correcting the shake, for example, displacing pixels of the image according to the direction and frequency of a shake acquired by the motion information acquisition unit 103b. The luminance correction processing is, for example, processing of performing a predetermined calculation on an input luminance level and adjusting an output luminance level. The gamma correction processing is, for example, processing of non-linearly transforming an RGB-signal and ensure visual linearity. The edge enhancement processing is, for example, processing of detecting edges from the image and increasing luminance of the detected edges to thereby enhance the light and shade of the image.

The reproduction unit 106 reproduces the image data whose image quality has been adjusted. The reproduction unit 106 can be realized by the display unit 16. The reproduction unit 106 may be capable of reproducing not only the image data but also audio acquired during capturing the moving image or the like. In this case, the reproduction unit 106 can be realized by the display unit 16 and the audio device unit 17.

Hereinafter, an operation example of the image processing apparatus 100 having the above-mentioned configuration will be described.

[Operation of Image Processing Apparatus]

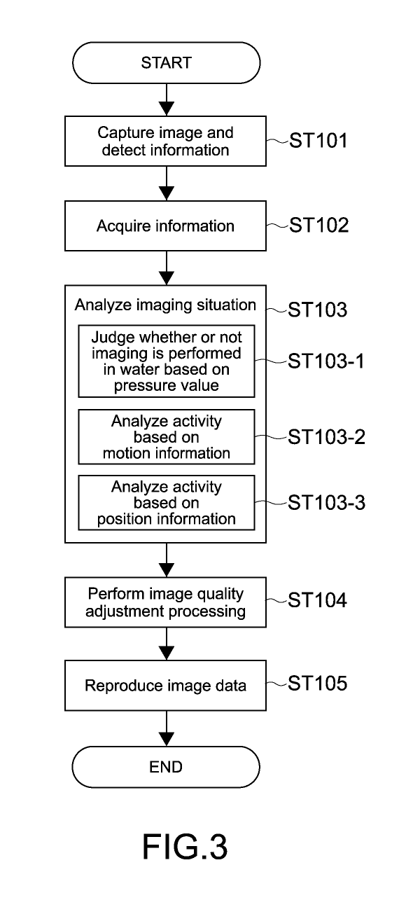

FIG. 3 is a flowchart showing an operation of the image processing apparatus 100.

First, the image data recording unit 101 captures and records a moving image (image) and at the same time the detection unit 102 detects information based on an activity of the user during capturing the moving image (ST101). Then, the information acquisition unit 103 acquires the detected information (ST102). Specifically, the pressure information acquisition unit 103a acquires a value of a pressure received during imaging of the user. The motion information acquisition unit 103b acquires motion information of the user. The position information acquisition unit 103c acquires position information of the user.

Next, based on the information acquired by the information acquisition unit 103, the analysis unit 104 analyzes an imaging situation of the moving image (ST103). This step may be performed in parallel with capturing the moving image or may be performed after capturing the moving image. If the step is performed after capturing the moving image, the step may be set to be performed after the user selects a mode for performing image quality adjustment according to the imaging situation. This mode may be selectable according to a predetermined input operation with respect to the operation unit 13, for example.

Specifically, the analysis unit 104 can analyze the imaging situation in the following manner. For example, the analysis unit 104 is capable of judging, based on the pressure value acquired by the pressure information acquisition unit 103a, whether or not imaging is performed in water (ST103-1). If it is judged that the imaging is performed in water, the analysis unit 104 can conclude that the activity performed during imaging of the user is an activity in water. If the pressure value is lower than the atmospheric pressure, the analysis unit 104 can conclude that the activity performed during imaging of the user is an activity in a high-altitude place including an activity in the air.

The analysis unit 104 is capable of analyzing, based on the motion information acquired by the motion information acquisition unit 103b, an activity performed along with capturing the moving image (ST103-2). For example, if the frequency of the vibration acquired by the motion information acquisition unit 103b is equal to or higher than a predetermined frequency, the analysis unit 104 can conclude that the activity is the imaging situation with a shake. In addition, the analysis unit 104 is also capable of analyzing a detailed activity by matching a value of an actually acquired acceleration and/or angular velocity with a pattern of a value of acceleration and/or angular velocity typically shown by a predetermined activity, for example, cycling, driving an automobile, or running.

The analysis unit 104 also analyzes, based on the position information, the activity performed along with capturing the moving image (ST103-3). The analysis unit 104 is capable of judging, for example, a position of the user (sea, land, lake, river, etc.). With this, for example, if the position of the user is judged as the sea, lake, or river, the analysis unit 104 can conclude that the activity is either one of an activity in water and an activity on water. In addition, the analysis unit 104 is also capable of judging an imaged place name, building name, or the like by matching the position of the user with map information or the like stored in the storage unit 14 or the like. With this, for example, if it is judged that the position of the user is a wedding place, it is possible to conclude that the activity is imaging at the wedding.

The analysis unit 104 may perform the above-mentioned analyses or judgment in a predetermined order. In this case, it is possible to gradually specify the imaging situation. Alternatively, a table showing imaging situation examples comprehensively analyzed based on the acquired information of the pressure information acquisition unit 103a, the motion information acquisition unit 103b, and the position information acquisition unit 103c may be created in advance and stored in the storage unit 14 or the like. Then, the analysis may be performed by referring the table. In this case, by referring the information acquired by the information acquisition unit 103 and the table, the imaging situation can be determined.

Next, the image quality adjustment unit 105 performs, based on the analyzed imaging situation, the image quality adjustment processing on the moving image data corresponding to the imaging situation (ST104). Also this step may be performed in parallel with capturing the moving image or may be performed after capturing the moving image. For example, if the activity is the imaging situation with vibration, the image quality adjustment unit may perform processing of correcting the vibration of the moving image data based on the frequency of the vibration.

Finally, the reproduction unit 106 reproduces the moving image (image) data whose image quality has been adjusted (ST105).

Hereinafter, operation examples in specific imaging situations will be described.

### Operation Example 1-1 Diving

As Operation Example 1-1, an example in which moving image data is captured during diving will be shown. In this case, a situation in which the user himself or herself is diving and performs imaging in water is assumed.

First, during capturing the moving image, information based on the activity of the user is detected (see ST101) and the information is acquired by the pressure information acquisition unit 103a, the motion information acquisition unit 103b, and the position information acquisition unit 103c (see ST102).

Next, the analysis unit 104 analyzes the imaging situation based on the acquired information (see ST103). For example, the analysis unit 104 can conclude that the imaging situation is the activity in water or on water based on the fact that the position information acquired by the position information acquisition unit 103c indicates that the position of the user is a sea (see ST103-3). Further, if judging, based on the pressure value acquired by the pressure information acquisition unit 103a, that the imaging is performed in water, the analysis unit 104 can conclude that the activity of the user is the activity in water (see ST103-1). In addition, if it is detected, based on the pressure value, that imaging is performed at a depth of water equal to or larger than a predetermined, the analysis unit 104 can conclude that the activity of the user is the diving. Moreover, the analysis unit 104 can conclude, based on the motion information acquired by the motion information acquisition unit 103b and a result of analysis indicating that the activity of the user is the activity in water, that the activity of the user is the diving (see ST103-2).

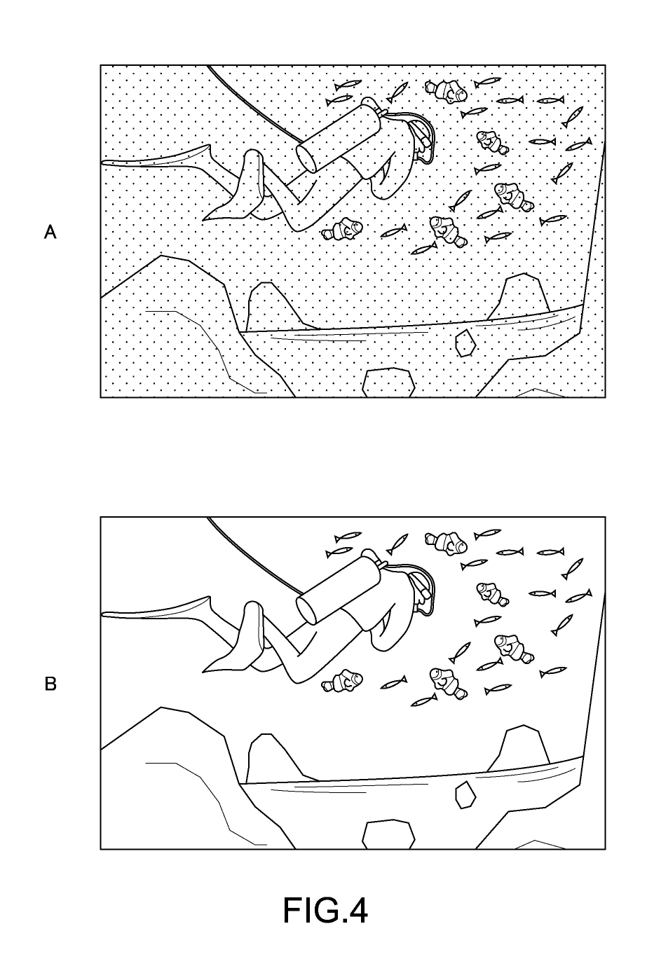

FIG. 4 is a schematic diagram showing an example of moving image data captured during diving. “A” shows moving image data before image quality adjustment. “B” shows the moving image data after the image quality adjustment. An image captured in water generally has a bluish color and an original natural hue cannot be obtained as shown in “A” of FIG. 4. In view of this, the image quality adjustment unit 105 performs hue correction processing of reducing a gain of blue (B) as the image quality adjustment processing of reducing the deterioration in image quality estimated based on the imaging situation in water (see ST104). Note that shake correction or the like may be selected as the image quality adjustment processing associated with imaging during the diving.

With this, as shown in “B” of FIG. 4, the reproduction unit 106 reproduces the moving image data having an almost original hue (see ST105).

### Operation Example 1-2 Cycling

As Operation Example 1-2, an example in which moving image data is captured during cycling will be shown. In this case, a situation in which the image processing apparatus 100 is attached to a bicycle on which the user himself or herself is riding and the user performs imaging of a landscape during cycling is assumed.

First, during capturing a moving image, information based on an activity of the user is detected (see ST101) and the information is acquired by the pressure information acquisition unit 103a, the motion information acquisition unit 103b, and the position information acquisition unit 103c (see ST102).

Next, the analysis unit 104 analyzes the imaging situation based on the acquired information (see ST103). For example, the analysis unit 104 can judge, based on the pressure value from the pressure information acquisition unit 103a, that the imaging is not performed in water (see ST103-1). Further, the analysis unit 104 can conclude that the imaging situation is not the activity in water or on water based on the fact that the position information acquired by the position information acquisition unit 103c indicates that the position of the user is a land (see ST103-3). The analysis unit 104 judges, based on the angular velocity of the information or the like from the motion information acquisition unit 103b, that a frequency of a shake acquired is a predetermined frequency or higher and concludes that the activity is the imaging situation with a shake (see ST103-2). In addition, if it is judged, based on acceleration information or the like from the motion information acquisition unit 103b, that the user is moving within a predetermined speed range, the analysis unit 104 may conclude that the activity of the user is the cycling.

The image quality adjustment unit 105 performs shake correction processing as the image quality adjustment processing of reducing the deterioration in image quality estimated based on the imaging situation with a shake (see ST104). More specifically, the image quality adjustment unit 105 may perform processing of correcting the vibration of the moving image data based on the frequency of the detected shake. The processing may also consider a direction of the detected shake.

With this, the reproduction unit 106 reproduces the moving image data whose shake has been suitably corrected (see ST105).

In the case of onboard imaging of the cycling or the like, a shake larger than a normal hand shake may occur and it may be difficult to address it by camera shake correction using an optical system or the like that assumes imaging of the user who holds a camera in a hand. According to this embodiment, the direction of the shake and the frequency can be detected by the motion information acquisition unit 103b. Therefore, suitable shake correction can be performed even with a large shake.

Regarding electronic shake correction, the shake is overcome generally by moving pixels in a predetermined direction, and hence some peripheral pixels of the pixels are lost and a reproduction range becomes smaller as a shake amount becomes larger. In particular, if the user himself or herself designates the shake amount and determines the correction amount, it is difficult to evaluate the shake amount. Therefore, there is a problem in that the reproduction range becomes narrow or the shake cannot be sufficiently overcome. According to this embodiment, it is possible to perform suitable correction based on the information from the motion information acquisition unit 103b. Therefore, the reproduction range becomes a suitable range and a degree of satisfaction of the user can be increased.

### Operation Example 1-3 Winter Sport

As Operation Example 1-3, an example in which moving image data is captured during snowboarding will be shown. In this case, a situation in which the user himself or herself is snowboarding and performs imaging on snow is assumed.

First, during capturing the moving image, the information based on the activity of the user is detected (see ST101) and the information is acquired by the pressure information acquisition unit 103a, the motion information acquisition unit 103b, and the position information acquisition unit 103c (see ST102).

Next, the analysis unit 104 analyzes the imaging situation based on the acquired information (see ST103). For example, the analysis unit 104 can conclude, based on the pressure value from the pressure information acquisition unit 103a, that the imaging is not performed in water, and, if the pressure value is lower than the atmospheric pressure, that the imaging is performed in a high-altitude place (see ST103-1). Further, if judging, based on the position information acquired by the position information acquisition unit 103c, that the position of the user is a ski resort, the analysis unit 104 can conclude that the imaging situation is the sport on snow (see ST103-3). In addition, the analysis unit 104 may conclude, based on the information acquired by the motion information acquisition unit 103b and a result of analysis indicating that the imaging situation is the sport on snow, that the imaging situation is, for example, the snowboarding (see ST103-2).

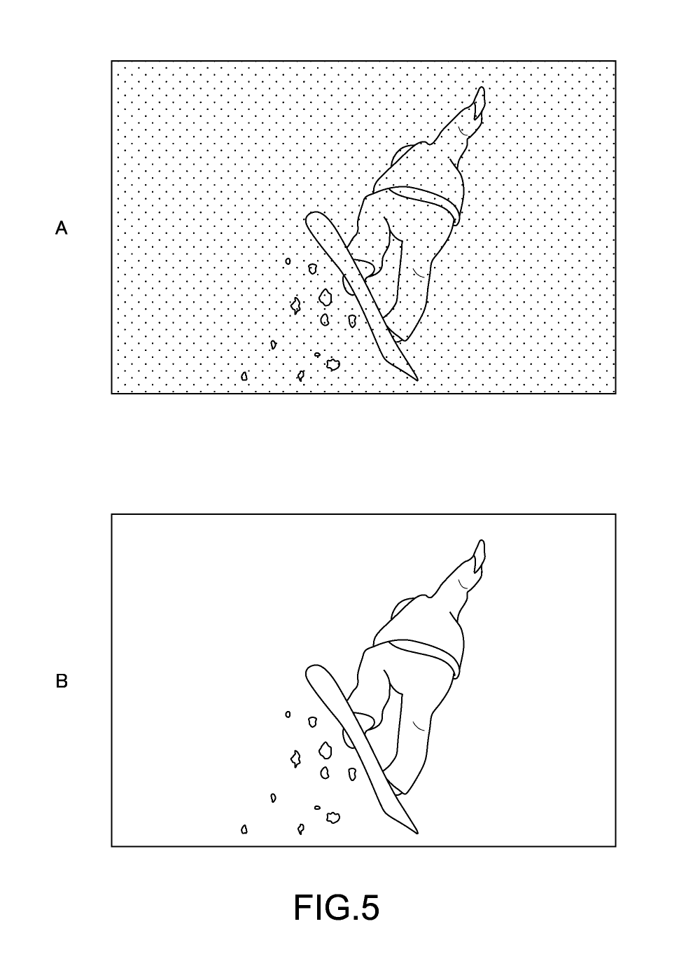

FIG. 5 is a schematic diagram showing an example of moving image data captured during snowboarding. “A” shows moving image data before image quality adjustment. “B” shows the moving image data after the image quality adjustment. An image captured on snow generally has high luminance and a whitish color, and hence an original hue cannot be obtained in some cases as shown in “A” of FIG. 5. In view of this, the image quality adjustment unit 105 performs luminance correction processing of reducing the luminance as the image quality adjustment processing of reducing the deterioration in image quality estimated based on the imaging situation on snow (see ST104).

Note that the image quality adjustment unit 105 may perform edge enhancement correction processing or the like and also perform shake correction processing or the like as the image quality adjustment processing associated with the imaging during the snowboarding. With this, the reproduction unit 106 reproduces the moving image data having an almost original hue as shown in “B” of FIG. 5 (see ST105).

### Operation Example 1-4 Sport on Sea

As Operation Example 1-4, an example in which moving image data is captured during windsurfing will be shown. In this case, a situation in which the user himself or herself is windsurfing and performs imaging on the sea (on water) is assumed.

First, during capturing the moving image, the information based on the activity of the user is detected (see ST101) and the information is acquired by the pressure information acquisition unit 103a, the motion information acquisition unit 103b, and the position information acquisition unit 103c (see ST102).

Next, the analysis unit 104 analyzes the imaging situation based on the acquired information (see ST103). For example, the analysis unit 104 judges, based on the pressure value acquired by the pressure information acquisition unit 103a, that the imaging is not performed in water (see ST103-1). Further, the analysis unit 104 can judge, based on the position information acquired by the position information acquisition unit 103c and the analysis indicating that the imaging is not performed in water, that the imaging is performed on the sea (see ST103-3). In addition, the analysis unit 104 can conclude, based on the motion information from the motion information acquisition unit 103b and the analysis indicating that the imaging is performed on the sea, that the activity of the user is the sport on the sea (see ST103-2). Note that the analysis unit 104 may conclude, based on the motion information, that the activity of the user is the windsurfing.

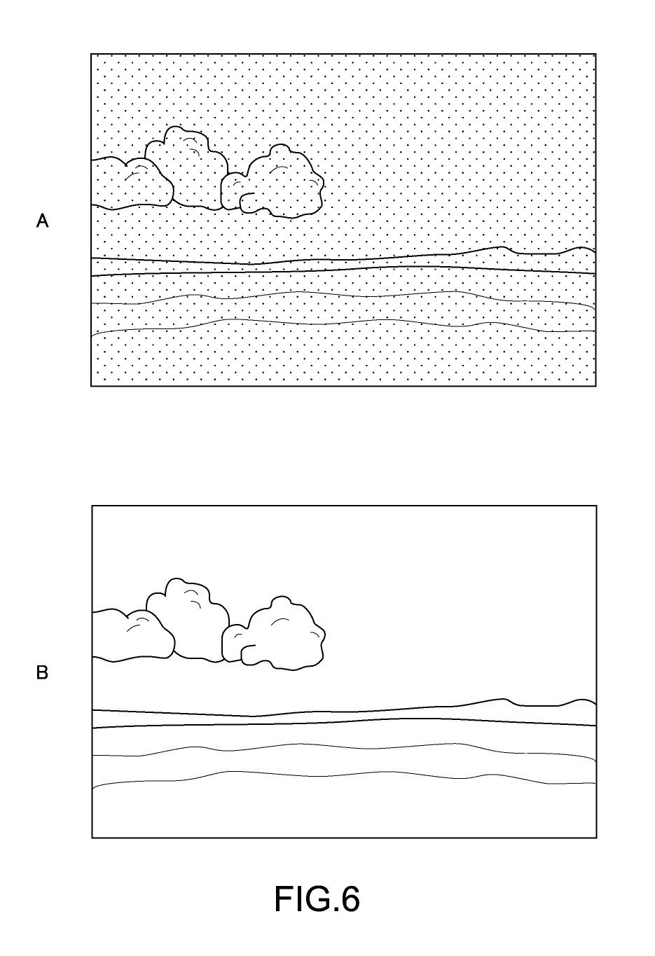

FIG. 6 is a schematic diagram showing an example of moving image data captured on the sea. “A” shows moving image data before image quality adjustment. “B” shows the moving image data after the image quality adjustment. In this case, the user may have an impression that the reproduced image is less blue and darker than the user thought and feel dissatisfied with this (A of FIG. 6). That is caused due to a difference between the color memorized by the user, i.e., the “memorized color” and the “recorded color” that is actually recorded. In view of this, the image quality adjustment unit 105 performs hue correction processing of increasing a gain of blue (B) as the image quality adjustment processing for making the recorded color closer to the memorized color (see ST104). Note that the shake correction or the like may be performed as the image quality adjustment processing associated with imaging during the windsurfing.

With this, the reproduction unit 106 reproduces the moving image data having a bright blue color, which is closer to the memorized color of the user, as shown in “B” of FIG. 6 (see ST105).

### Operation Example 1-5 Wedding

As Operation Example 1-5, an example in which moving image data is captured during wedding will be shown. In this case, a situation in which imaging is performed in a wedding place is assumed.

First, during capturing the moving image, the information based on the activity of the user is detected (see ST101) and the information is acquired by the pressure information acquisition unit 103a, the motion information acquisition unit 103b, and the position information acquisition unit 103c (see ST102).

Next, the analysis unit 104 analyzes the imaging situation based on the acquired information (see ST103). For example, the analysis unit 104 can conclude, based on the pressure value acquired by the pressure information acquisition unit 103a, that the imaging is performed in water (see ST103-1). Further, if detecting, based on the motion information acquired by the motion information acquisition unit 103b, a motion of keeping almost the same attitude and sometimes slowly changing the attitude, the analysis unit 104 can conclude that the imaging is performed in an event (see ST103-2). Further, the analysis unit 104 can conclude, if it is judged that the position of the user is a wedding place or a hotel based on the position information acquired by the position information acquisition unit 103c and the conclusion that the imaging is performed in an event, that the imaging is performed during a wedding (see ST103-3).

In general, an image captured during the wedding is often dark because the image is captured inside. In view of this, the image quality adjustment unit 105 performs correction processing of increasing the luminance as the image quality adjustment processing of reducing the deterioration in image quality estimated based on the imaging situation of the wedding (see ST104). Note that the image quality adjustment unit 105 may perform correction processing of slightly increasing a gain of red (R) as the image quality adjustment processing according to a theme of the imaging situation. With this, the happy mood of the wedding can be expressed.

With this, the reproduction unit 106 can reproduce the moving image data suitable for the wedding (see ST105).

As described above, according to this embodiment, the imaging situation is analyzed based on the motion information, the position information, and the like that are detected based on the activity performed along with capturing the moving image. It becomes possible to automatically perform, based on this imaging situation, the image quality adjustment processing on the moving image data. With this, without needing the user to perform the image quality adjustment operation during imaging, it becomes possible to reproduce the moving image data subjected to suitable image quality adjustment processing after imaging. Further, it becomes possible to save the time and effort of the user to manually select the image quality adjustment processing after imaging.

In particular, if the user performs imaging while the user himself or herself is performing a sport, the image quality is often deteriorated and furthermore it is difficult to perform the image quality adjustment operation during imaging. According to this embodiment, the image quality adjustment operation during imaging becomes unnecessary and it becomes possible to reproduce the moving image data having a desired image quality even in the case of moving image data of a sport scene, whose image quality can be easily deteriorated.

Further, if imaging is performed in a special environment, for example, in water, on snow, or on water, in image processing such as auto white balance and auto exposure adjustment that can be set during imaging, the adjustment is often insufficient. According to this embodiment, it becomes possible for the image processing apparatus 100 to perform more suitable image quality adjustment processing. Therefore, even if the moving image data is captured in the special environment, sufficient image quality adjustment becomes possible.

### Modified Example 1-1

In the above-mentioned embodiment, the analysis unit 104 analyzes the imaging situation of the image based on the information from the information acquisition unit 103. However, the analysis unit 104 is not limited thereto. For example, the analysis unit 104 may analyze the imaging situation of the image based on information extracted by analyzing a feature of a subject in the captured image data in addition to the information from the information acquisition unit 103.

Specifically, the analysis unit 104 is capable of analyzing the imaging situation by analyzing the feature of the subject using an image analysis/recognition technique.

According to this modified example, for example, it is possible to enhance the analysis accuracy of the imaging situation even in an event scene or the like with few motions. Thus, it is possible to perform more suitable image quality adjustment on the image data.

### Modified Example 1-2

In the above-mentioned embodiment, the analysis unit 104 analyzes the imaging situation of the image based on the information from the information acquisition unit 103. The analysis unit 104 is not limited thereto. For example, the analysis unit 104 may analyze the imaging situation of the image based on information extracted from audio data recorded along with capturing the image in addition to the information from the information acquisition unit 103.

Specifically, the analysis unit 104 is capable of analyzing which of a loud imaging situation and a silent situation the situation is by analyzing the volume of the recorded audio data. In addition, the analysis unit 104 may analyze the type of sound recorded during imaging (human voice, sound of wind or waves, etc.) and the contents of a speech according to a sound recognition technique to thereby analyze the imaging situation.

According to this modified example, it is possible to enhance the analysis accuracy of the imaging situation even in an event scene or the like with few motions, for example. Thus, it is possible to perform more suitable image quality adjustment on the image data.

Note that, in this modified example, the analysis unit 104 may use the information from the information acquisition unit 103 and the information extracted from the audio data as well as the information extracted by analyzing the feature of the subject in the image data described in Modified Example 1-1. With this, it is possible to further enhance the analysis accuracy of the imaging situation.

### Second Embodiment

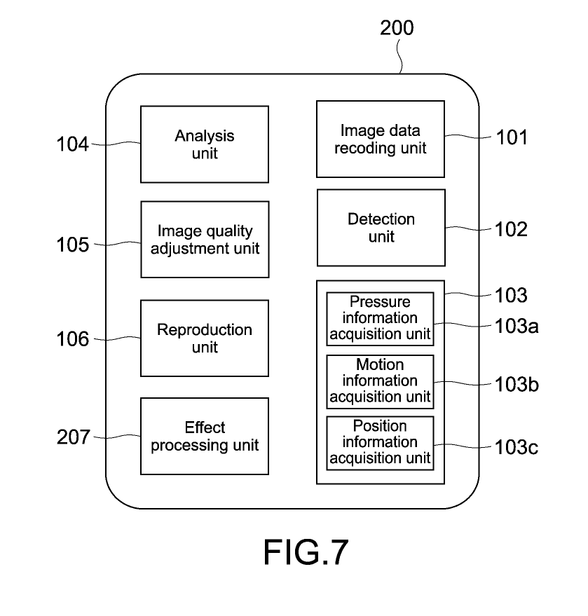

FIG. 7 is a block diagram showing a functional configuration of an image processing apparatus 200 according to a second embodiment. The image processing apparatus 200 includes an effect processing unit 207 in addition to an image data recording unit 101, a detection unit 102, an information acquisition unit 103, an analysis unit 104, an image quality adjustment unit 105, and a reproduction unit 106 that are the same as those of the image processing apparatus 100. Also in this embodiment, it is assumed that the image data is the moving image data. Note that, in the following description, the same components as those of the above-mentioned embodiment will be denoted by the same reference symbols and descriptions thereof will be omitted. Further, the image processing apparatus 200 has the same hardware configuration as the image processing apparatus 100, and hence a description thereof will be omitted.

The effect processing unit 207 performs, based on the analyzed imaging situation, effect processing on the image data corresponding to the imaging situation. The effect processing unit 207 may perform effect processing stored in association with the analyzed imaging situation, for example. Alternatively, the effect processing unit 207 may select, according to stored predetermined algorithm, effect processing based on the imaging situation and perform the selected effect processing. The effect processing unit 207 outputs the image data subjected to the effect processing, to the reproduction unit 106. The effect processing unit 207 is realized by, for example, the controller 11. A correspondence relationship between the effect processing and the imaging situation is stored in the storage unit 14. The example of this correspondence relationship will be described later.

Here, the “effect processing of the image data” means processing of adding an effect to image data and audio recorded together with the image data by reproducing the image data together with additional information, image, and audio or reproducing the image data with a predetermined template or the like. As a specific example of the effect processing, there is exemplified processing of displaying predetermined information (hereinafter, referred to as additional information) of the information acquired by the information acquisition unit 103 with the image data. Regarding the display state, the additional information may be displayed in the image data in an overlapping manner or the image data may be reduced in size and displayed in a margin of a display area. A correspondence relationship between the additional information (also including display state) and each imaging situation may be stored in the storage unit 14 or the like.

[Operation of Image Processing Apparatus]

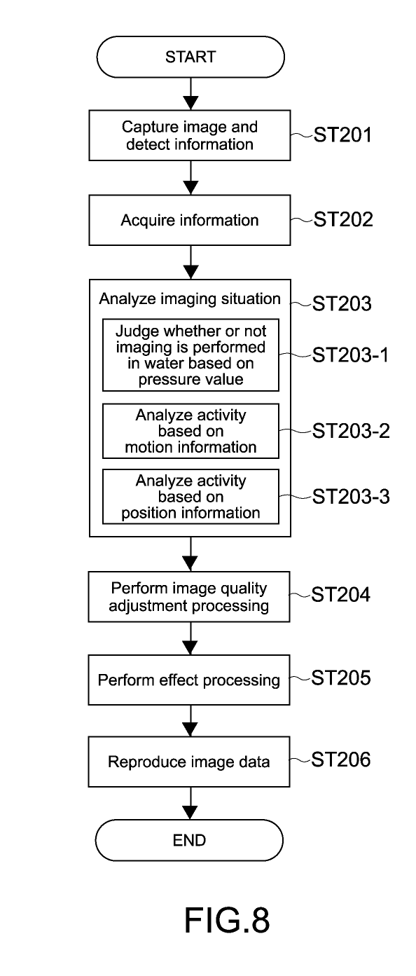

FIG. 8 is a flowchart showing an operation of the image processing apparatus 200.

First, as in ST101 of FIG. 3, a moving image is captured and at the same time the detection unit 102 detects information based on an activity of the user during capturing the moving image (image) (ST201). Then, the information acquisition unit 103 acquires the detected information (ST202).

Next, as in ST102 of FIG. 3, the analysis unit 104 analyzes, based on the information acquired by the information acquisition unit 103, the imaging situation of the moving image (ST203). The analysis unit 104 may judge, based on, for example, a pressure value, whether or not the imaging is performed in water (ST203-1) or analyze, based on a motion information, the activity performed along with capturing the moving image (ST203-2). Alternatively, the analysis unit 104 may analyze, based on the position information, the activity performed along with capturing the moving image (ST203-3).

Next, as in ST103 of FIG. 3, the image quality adjustment unit 105 performs, based on the analyzed imaging situation, image quality adjustment processing on the moving image data corresponding to the imaging situation (ST204).

In addition, the effect processing unit 207 performs, based on the analyzed imaging situation, effect processing on the moving image data corresponding to the imaging situation (ST205).

Finally, the reproduction unit 106 reproduces the moving image (image) data subjected to the image quality adjustment processing and the effect processing (ST206).

Note that, before the image quality adjustment processing is performed (ST204), the step of performing the effect processing (ST205) may be performed.

Hereinafter, operation examples in specific imaging situations will be described.

### Operation Example 2-1 Cycling

As Operation Example 2-1, an example in which moving image data is captured during cycling will be shown. In this case, ST201 to ST204 are the same as ST101 to ST104 described above, and hence a step corresponding to ST205 and the subsequent steps will be described.

The effect processing unit 207 performs, based on the imaging situation of the cycling, effect processing on the moving image data subjected to the image quality adjustment processing (see ST205). Here, as the effect processing, effect processing of displaying a running speed and a running track as the additional information in the moving image data is performed. The running speed can be determined mainly based on the acceleration information from the motion information acquisition unit 103b. Further, the running track can be determined mainly based on the position information from the position information acquisition unit 103c. Note that the additional information is not limited to the above and a period of time from the start of driving, a date and time, or the like may be displayed.

With this, the reproduction unit 106 reproduces the moving image data subjected to the image quality adjustment processing and the effect processing (see ST206).

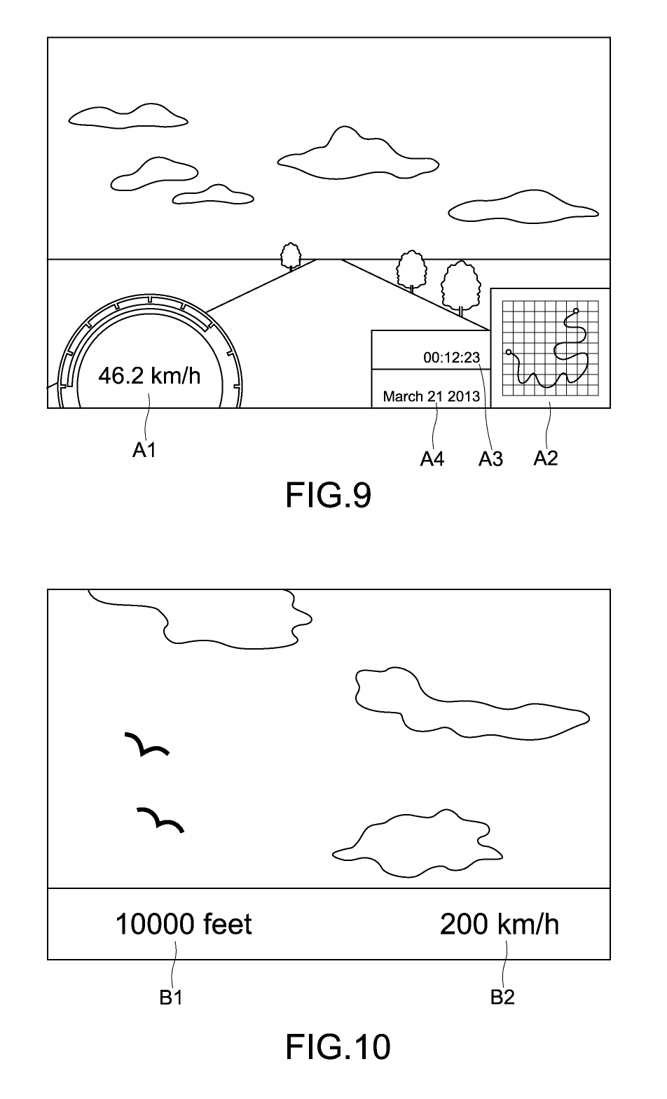

FIG. 9 is a schematic diagram showing an example of the moving image data obtained by performing the effect processing on the moving image data captured during the cycling. As shown in the figure, the symbols A1 to A4 of the figure are additional information. A1 indicates a running speed, A2 indicates a running track, A3 indicates a period of time from the start of cycling, and A4 shows a date and time. FIG. 9 shows an example of the effect processing of displaying the additional information in the moving image data in an overlapping manner. With such moving image data, the situation during imaging can be more objectively recognized.

### Operation Example 2-2 Skydiving

As Operation Example 2-2, an example in which moving image data is captured during skydiving will be shown. In this case, a situation in which the user himself or herself is skydiving and performs imaging in the air is assumed.

First, during capturing the moving image, the information based on the activity of the user is detected (see ST201) and the information is acquired by the pressure information acquisition unit 103a, the motion information acquisition unit 103b, and the position information acquisition unit 103c (see ST202).

Next, the analysis unit 104 analyzes the imaging situation based on the acquired information (see ST203). For example, if judging, based on the pressure value acquired by the pressure information acquisition unit 103a, that imaging under low atmospheric pressure, the analysis unit 104 can conclude that the imaging situation is an activity in a high-altitude place such as air sports and mountain climbing (see ST203-1). Further, the analysis unit 104 is capable of judging, based on the motion information acquired by the motion information acquisition unit 103b, that the activity of the user is skydiving (see ST203-2). Specifically, in the case of the skydiving, the user falls down with extremely high acceleration immediately after the user dives out of an airplane or the like, and hence it can be concluded that the activity of the user is the skydiving, by detecting the high acceleration. Further, the analysis unit 104 may refer to the position information acquired by the position information acquisition unit 103c (see ST203-3).

Similar to the activity on water, the memorized color and the recorded color of an image captured in the air may differ from each other and an image close to that the user thought may not be obtained. In view of this, the image quality adjustment unit 105 may perform hue correction processing of increasing a gain of blue (B) as the image quality adjustment processing for making the recorded color closer to the memorized color (see ST204). Further, there is a fear that a shake occurs due to a wind pressure in the air, and hence the image quality adjustment unit 105 may perform the above-mentioned shake correction processing. If intensive solar light is captured together with a person and the like, a difference in luminance or the like of the image data becomes large. Therefore, contrast correction processing for preventing so-called blown-out highlights or blocked-up shadows may be performed.

Next, the effect processing unit 207 performs, based on the analyzed imaging situation, the effect processing (see ST205). Here, as the effect processing, the effect processing unit 207 performs effect processing of displaying an altitude and fall velocity as the additional information together with the moving image data. The altitude can be determined mainly based on the pressure value from the pressure information acquisition unit 103a. The fall velocity can be determined mainly based on the acceleration information from the motion information acquisition unit 103b.

The reproduction unit 106 reproduces the moving image data subjected to the image quality adjustment processing and the effect processing (see ST206).

FIG. 10 is a schematic diagram showing an example of the moving image data obtained by performing the effect processing on the moving image data captured during the skydiving. The symbols B1 and B2 of the figure show additional information and B1 indicates an altitude and B2 indicates fall velocity. FIG. 10 shows an example of effect processing of reducing the moving image data and displaying the additional information in the margin of the display area.

As described above, according to this embodiment, it becomes possible to automatically perform the effect processing of the image data based on the imaging situation of the image in addition to the image quality adjustment. With this, it becomes possible to save the time and effort of the user to manually select the effect processing.

Note that the image processing apparatus 200 may apply various types of effect processing.

### Modified Example 2-1

In the above-mentioned embodiment, as the effect processing, the processing of displaying the additional information together with the image data. The effect processing is not limited thereto. The effect processing may be, for example, processing for creating a short movie from the moving image data. In this case, the effect processing unit 207 may select, based on the imaging situation, a template for creating the short movie and perform effect processing using this template. Here, the template may include the image quality adjustment processing or may include the audio data.

For example, if it is concluded that the imaging is performed during the wedding, the effect processing unit 207, for example, selects a template stored in association with the imaging during the wedding and performs effect processing using this template. With this, the short movie can be reproduced.

Such an effect processing unit 207 enables the user to easily create, from the moving image data captured by himself or herself, the short movie with the template suitable for the imaging situation. Therefore, the time and effort of the user to select the template can be saved and the user can enjoy the short movie more easily.

### Modified Example 2-2

The effect processing may be processing of displaying the contents of a conversation extracted from the audio data recorded during imaging together with the image data. The contents of the conversation can be extracted from audio data recorded during imaging according to the sound recognition technology. Further, the effect processing may be processing of displaying the contents of the conversation in the image data in an overlapping manner or may be processing of reducing the image data in size and displaying the reduced image data in a margin of a display area. With this, for example, even in the case of the moving image data in a situation where it is difficult to listen to audio, it becomes possible to provide moving image data from which the contents of the conversation can be understood.

### Other Modified Examples

Also in this embodiment, the analysis unit 104 may perform the analysis using the information from the information acquisition unit 103 as well as the information extracted by analyzing the feature of the subject in the image data described in the modified example 1-1 and the information extracted from the audio data during imaging described in Modified Example 1-2. With this, it becomes possible to enhance the analysis accuracy of the analysis unit 104 for the imaging situation and the effect processing unit 207 can select a more suitable effect processing method.

### Third Embodiment

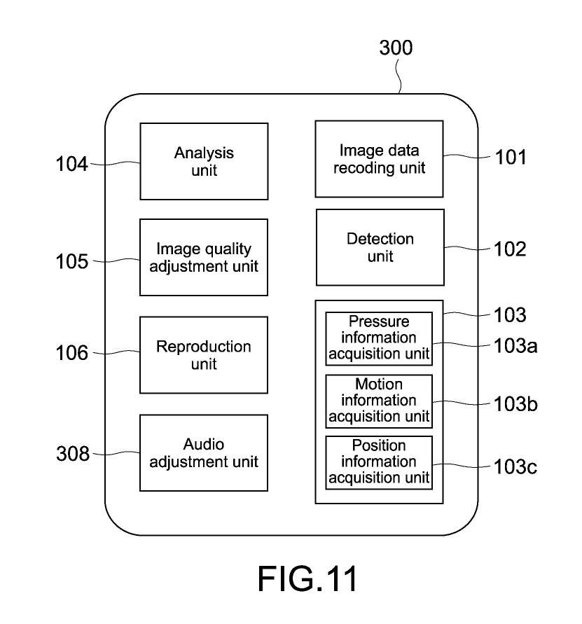

FIG. 11 is a block diagram showing a functional configuration of an image processing apparatus 300 according to a third embodiment. The image processing apparatus 300 includes an audio adjustment unit 308 in addition to an image data recording unit 101, a detection unit 102, an information acquisition unit 103, an analysis unit 104, an image quality adjustment unit 105, and a reproduction unit 106 that are the same as those of the image processing apparatus 100. Also in this embodiment, it is assumed that the image data is the moving image data. Note that, in the following description, the same components as those of the above-mentioned embodiments will be denoted by the same reference symbols and descriptions thereof will be omitted. Further, the image processing apparatus 300 has the same hardware configuration as the image processing apparatus 100, and hence a description thereof will be omitted.

The audio adjustment unit 308 performs, based on analyzed imaging situation, audio adjustment processing on audio data recorded along with capturing an image. The audio adjustment unit 308 is realized by, for example, the controller 11. The audio adjustment unit 308 may perform audio adjustment processing stored in association with the analyzed imaging situation, for example. In this case, a correspondence relationship between the audio adjustment processing and the imaging situation is stored in the storage unit 14. Alternatively, the audio adjustment unit 308 selects, according to the stored predetermined algorithm, audio adjustment processing based on the imaging situation and perform the selected audio adjustment processing. In some imaging situations, it may be difficult to listen to a human conversation or the volume of wind and rain noise may be high in the case where imaging is performed outside. In these cases, processing of adjusting the sound and noise volume can be performed. An example of the correspondence relationship will be described later.

### Operation of Image Processing Apparatus

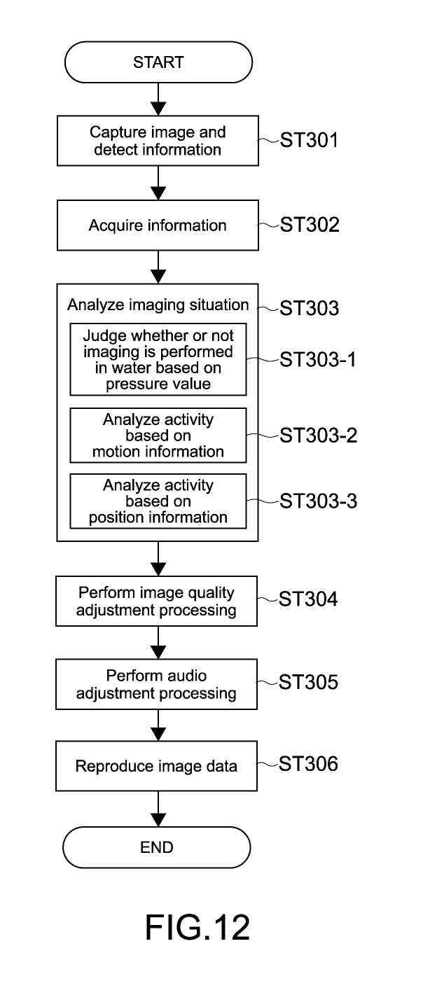

FIG. 12 is a flowchart showing an operation of the image processing apparatus 300. Note that, in the following operation example, a description will be made, assuming that the moving image data is used as the image data.

First, as in ST101 of FIG. 3, the image data recording unit 101 captures and records moving image (image) and at the same time the detection unit 102 detects information during capturing a moving image based on an activity of the user (ST301). During capturing the moving image, the audio data is also recorded. Then, the information acquisition unit 103 acquires the detected information (ST302).

Next, as in ST102 of FIG. 3, based on the information acquired by the information acquisition unit 103, the analysis unit 104 analyzes the imaging situation of the moving image (ST303). The analysis unit 104 may judge, based on, for example, a pressure value, whether or not the imaging is performed in water (ST303-1) or may analyze, based on motion information, the activity performed along with capturing the moving image (ST303-2). Alternatively, the activity performed along with capturing the moving image may be analyzed based on position information (ST303-3).

Next, as in ST103 of FIG. 3, the image quality adjustment unit 105 performs, based on the analyzed imaging situation, the image quality adjustment processing on the moving image data corresponding to the imaging situation (ST304).

Then, the audio adjustment unit 308 performs, based on the analyzed imaging situation, audio adjustment processing on the audio data recorded along with capturing the moving image (ST305). The audio adjustment unit 308 is capable of, based on the imaging situation of the skydiving, performing processing of lowering the level of audio recognized as wind and increasing the level of audio recognized as a human conversation as the audio adjustment processing. Alternatively, the audio adjustment unit 308 is capable of, based on the imaging situation of the cycling, performing processing of lowering the level of audio noise due to the vibration (shake) as the audio adjustment processing.

Finally, the reproduction unit 106 reproduces the moving image (image) data subjected to the image quality adjustment together with the audio data whose output has been adjusted by the audio adjustment unit 308 (ST306).

In this manner, according to this embodiment, it is possible to adjust the output of the audio data according to the imaging situation. Thus, it is possible to enjoy the image data whose image quality has been adjusted as well as the audio data suitable for the imaging situation.

### Fourth Embodiment

In each of the above-mentioned embodiments, capturing the image, the image processing, and the reproduction are performed by the single apparatus. However, as in the following embodiment, these operations may be performed by an image processing system including a plurality of apparatuses.

[Hardware Configuration of Image Processing System]

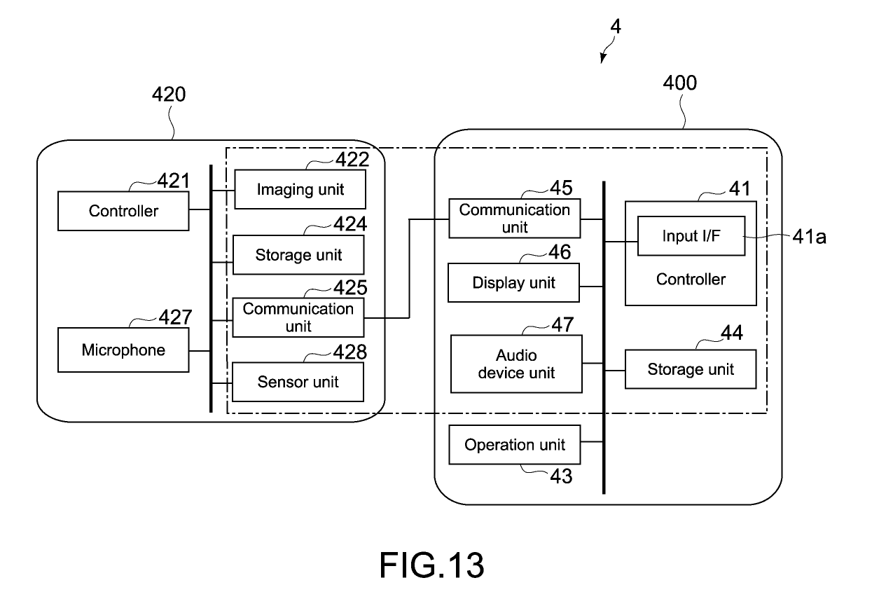

FIG. 13 is a block diagram showing a hardware configuration of an image processing system 4 according to a fourth embodiment of the present technology. The image processing system 4 includes an image processing apparatus 400 and an imaging apparatus 420. The image processing system 4 is configured such that the image processing apparatus 400 can perform the image processing on the image data captured by the imaging apparatus 420 and the image data can be reproduced. The image processing apparatus 400 and the imaging apparatus 420 are configured to be communicable with each other. Note that, also in this embodiment, it is assumed that the image data is the moving image data.

The imaging apparatus 420 includes a controller 421, an imaging unit 422, a storage unit 424, a communication unit 425, a microphone 427, and a sensor unit 428. Note that the imaging apparatus 420 may include, in addition to those components, a display unit, a speaker, and an operation unit (not shown). The imaging apparatus 420 may be an apparatus dedicated to imaging or may be a portable information terminal such as a smart phone. The imaging apparatus 420 is configured to be capable of capturing a moving image as in the image processing apparatus 100. The imaging apparatus 420 may be worn by the user or may be adapted for onboard imaging or imaging in water.

The controller 421 includes a CPU and comprehensively controls the respective units of the imaging apparatus 420. The imaging unit 422 obtains image data from an optical image of the subject. The storage unit 424 is configured by recoding media, a recording and reproducing mechanism for the recoding media, and the like. The storage unit 424 is configured to be capable of storing image data captured by the imaging unit 422. The microphone 427 is configured to be capable of receiving audio data. The sensor unit 428 includes an acceleration sensor, a pressure sensor, an angular velocity sensor, a geomagnetic sensor, and the like. The communication unit 425 is configured to be communicable with the image processing apparatus 400 and capable of transmitting a sensor value detected by the sensor unit 428 and stored image data to the image processing apparatus 400.

The image processing apparatus 400 includes a controller 41, an operation unit 43, a storage unit 44, a communication unit 45, a display unit 46, and an audio device unit 47. The units of the controller 41, the operation unit 43, the storage unit 44, the communication unit 45, the display unit 46, and the audio device unit 47 are connected to one another via a bus and configured to be capable of transferring data and transmitting and receiving a control signal. The image processing apparatus 400 is configured by, for example, the information processing apparatus. Specifically, the image processing apparatus 400 may be a personal computer (PC), a tablet, a smart phone, or the like.

A schematic configuration of the controller 41, the operation unit 43, the storage unit 44, the communication unit 45, the display unit 46, and the audio device unit 47 is the same as that of the controller 11, the operation unit 13, the storage unit 14, the communication unit 15, the display unit 16, and the audio device unit 17, and hence will be simplified and described hereinafter.

The controller 41 includes a CPU and comprehensively controls the respective units of the image processing apparatus 400. The controller 41 performs predetermined processing according to a control program stored in a ROM (not shown) or the storage unit 44. Note that the controller 41 includes an input I/F 41a into which information input from the imaging apparatus 420 through the communication unit 45 which will be described later is input.

The operation unit 43 includes, for example, a hardware key such as a keyboard, a touch panel, and a power-supply button and an input device such as an operation dial. The operation unit 43 detects an input operation of the user and transmits the input operation to the controller 41. The operation unit 43 may be configured to be capable of, for example, starting and ending capturing of the moving image, selecting a mode of performing the image quality adjustment according to the imaging situation and the like, and reproducing the image data.

The storage unit 44 can be configured by, for example, recoding media and a recording and reproducing mechanism for the recoding media.

The communication unit 45 is configured to be capable of communicating with a network through a communication system such as a wired LAN, a wireless LAN, an LTE, and a 3G and can be connected to a peripheral device via an external bus or the like of predetermined standards, for example. The communication unit 45 is configured to be communicable with the imaging apparatus 420. Note that the communication unit 45 may include another communication system.

The display unit 46 may be realized by, for example, a display element such as an LCD and an organic EL panel and have a function as a finder.

The audio device unit 47 includes a microphone and a speaker.

In the image processing system 4 having the hardware configuration as described above, a section shown in the alternate long and short dash line of FIG. 13, i.e., the imaging unit 422, the storage unit 424, the communication unit 425, and the sensor unit 428 of the imaging apparatus 420 and the controller 41, the storage unit 44, the communication unit 45, the display unit 46, and the audio device unit 47 of the image processing apparatus 400 has a functional configuration as follows.

[Functional Configuration of Image Processing System]

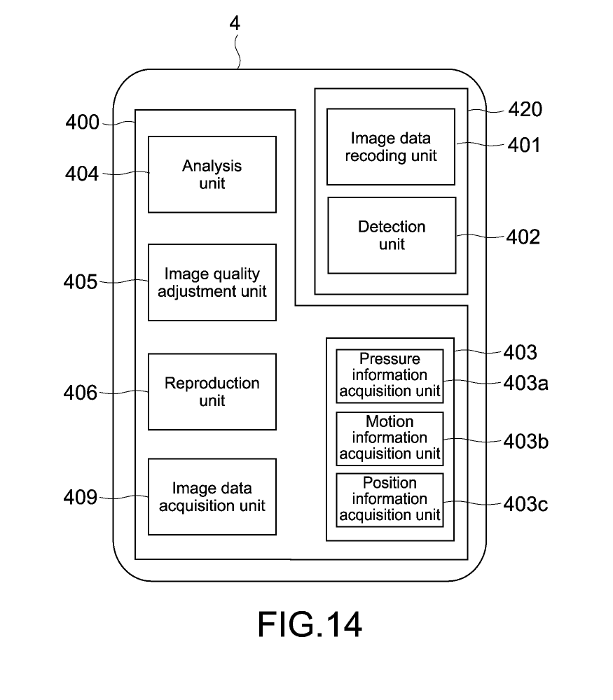

FIG. 14 is a block diagram showing a functional configuration of the image processing system 4. As shown in the figure, the image processing system 4 includes an image data recording unit 401, a detection unit 402, an information acquisition unit 403, an analysis unit 404, an image quality adjustment unit 405, a reproduction unit 406, and an image data acquisition unit 409. Among them, the image processing apparatus 400 includes the information acquisition unit 403, the analysis unit 404, the image quality adjustment unit 405, the reproduction unit 406, and the image data acquisition unit 409 and the imaging apparatus 420 includes the image data recording unit 401 and the detection unit 402.

The image data recording unit 401 captures an image, records the image as data, and transmits the image data in response to a request of the image data acquisition unit 409. The image data recording unit 401 is realized by, for example, the imaging unit 421, the storage unit 424, and the communication unit 425 of the imaging apparatus 420.

The detection unit 402 detects information based on an activity of the user during capturing an image and transmits the information in response to a request of the information acquisition unit 403. The detection unit 402 is realized by, for example, the sensor unit 428 and the communication unit 425 of the imaging apparatus 420. The detection unit 402 is configured to be capable of detecting a pressure value received during imaging of the user, motion information during imaging of the user, position information during imaging of the user, and the like.

The information acquisition unit 403 acquires the information detected based on the activity of the user during capturing the image. The information acquisition unit 403 is capable of acquiring at least any of a pressure value, motion information, and position information based on the activity performed along with capturing the image. That is, the information acquisition unit 403 includes a pressure information acquisition unit 403a, a motion information acquisition unit 403b, and a position information acquisition unit 403c. The pressure information acquisition unit 403a acquires a pressure value received during imaging of the user. The motion information acquisition unit 403b acquires motion information during imaging of the user, i.e., information on acceleration, angular velocity, and the like. The position information acquisition unit 403c acquires position information during imaging of the user. The information acquisition unit 403 is realized by, for example, the input I/F 41a of the controller 41.

The analysis unit 404 analyzes the imaging situation of the image based on the information acquired by the information acquisition unit 403 as in the analysis unit 104. The analysis unit 404 is realized by, for example, the controller 41.

The image quality adjustment unit 405 performs, based on the analyzed imaging situation, the image quality adjustment processing on the image data corresponding to the imaging situation as in the image quality adjustment unit 105. The image quality adjustment unit 405 is realized by, for example, the controller 41. A correspondence relationship between the image quality adjustment processing and the imaging situation is stored in the storage unit 44.

The reproduction unit 406 reproduces the image data whose image quality has been adjusted and also reproduces the audio data acquired during capturing the image. The reproduction unit 406 is realized by, for example, the display unit 46 and the audio device unit 47.

The image data acquisition unit 409 acquires the image data corresponding to the imaging situation. Specifically, the image data acquisition unit 409 acquires the image data recoded by the image data recording unit 401 through the communication unit 45. The image data acquisition unit 409 is realized by, for example, the input I/F 41a of the controller 41. The image data acquisition unit 409 may be configured to be capable of acquiring the audio data recorded during capturing the image.

[Operation Example of Image Processing System]

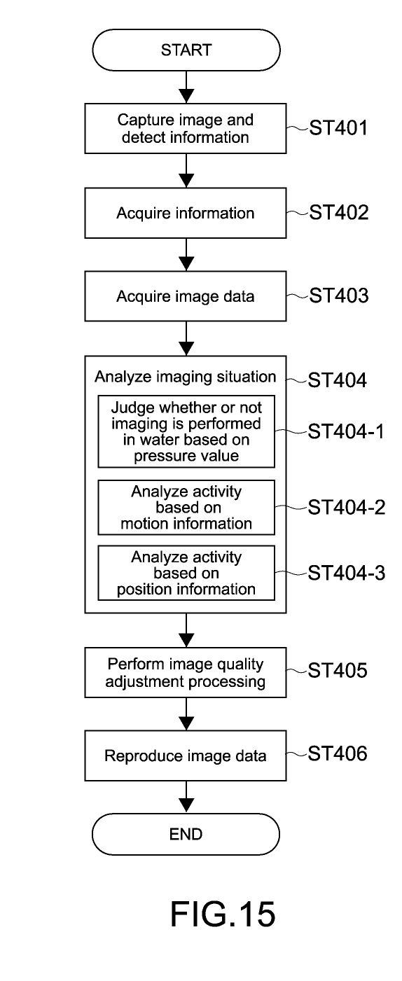

FIG. 15 is a flowchart showing an operation of the image processing system 4.

First, the imaging apparatus 420 captures and records the moving image and at the same time the detection unit 402 detects the information based on the activity of the user during capturing the moving image (image) (ST401). Then, the information acquisition unit 403 of the image processing apparatus 400 requests the detection unit 402 to transmit detected information to thereby acquire the information (ST402). The transmission request may be performed based on an input operation of the user with respect to the image processing apparatus 400. The information acquisition unit 403 can acquire, for example, a pressure value, motion information, position information, and the like.

Then, the image data acquisition unit 409 of the image processing apparatus 400 requests the image data recording unit 401 to transmit moving image data to thereby acquire the captured moving image data (ST403). The transmission request may be performed based on an input operation of the user with respect to the image processing apparatus 400.

Next, based on the information acquired by the information acquisition unit 403, the analysis unit 404 of the image processing apparatus 400 analyzes the imaging situation of the moving image data (ST404). The analysis unit 404 may judge, based on, for example, a pressure value, whether or not the imaging is performed in water (ST404-1) or may analyze, based on motion information, the activity performed along with capturing the moving image (ST404-2). Alternatively, the analysis unit 404 may analyze, based on position information, the activity performed along with capturing the moving image (ST404-3).

Next, as in ST104 of FIG. 3, the image quality adjustment unit 405 performs, based on the analyzed imaging situation, image quality adjustment processing on the moving image data corresponding to the imaging situation (ST405).

Finally, the reproduction unit 506 of the image processing apparatus 500 reproduces the moving image (image) data subjected to the image quality adjustment processing (ST406).

Also with the image processing apparatus 400 having the above-mentioned configuration, the image quality adjustment processing can be performed as in the image processing apparatus 100. That is, also in this embodiment, the imaging situation is analyzed based on the motion information, the position information, and the like that are detected based on the activity performed along with imaging the image. It becomes possible to automatically perform, based on this imaging situation, the image quality adjustment processing on the image data.

Regarding imaging in a sport scene, the imaging can be performed in a special environment, for example, in water, on snow, or on water, and hence, in image processing such as auto white balance and auto exposure adjustment of the imaging apparatus 420, the adjustment is often insufficient. According to this embodiment, the image processing apparatus 400 can perform more suitable image quality adjustment processing. Therefore, even if the image data is captured in the special environment, sufficient image quality adjustment becomes possible.

In addition, according to this embodiment, an information processing apparatus having a relatively memory capacity, for example, a PC can be employed as the image processing apparatus 400. Thus, it is possible to increase the image processing speed and it becomes easy to realize desired image processing.

### Modified Example 4-1

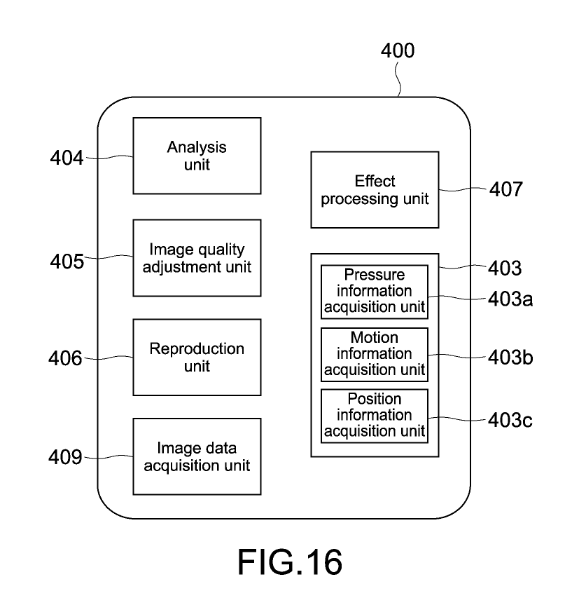

As shown in a block diagram of FIG. 16, an image processing apparatus 400 may include an effect processing unit 407 in addition to an information acquisition unit 403, an analysis unit 404, an image quality adjustment unit 405, a reproduction unit 406, and an image data acquisition unit 409. The effect processing unit 407 performs, based on the analyzed imaging situation, the effect processing on the image data corresponding to the imaging situation as in the effect processing unit 207. With this, it is possible to perform, based on the imaging situation of the image, not only the image quality adjustment but also the effect processing of the image data. Thus, also in this embodiment, it is possible to easily generate image data with an effect and reproduce the generated image data.

### Modified Example 4-2

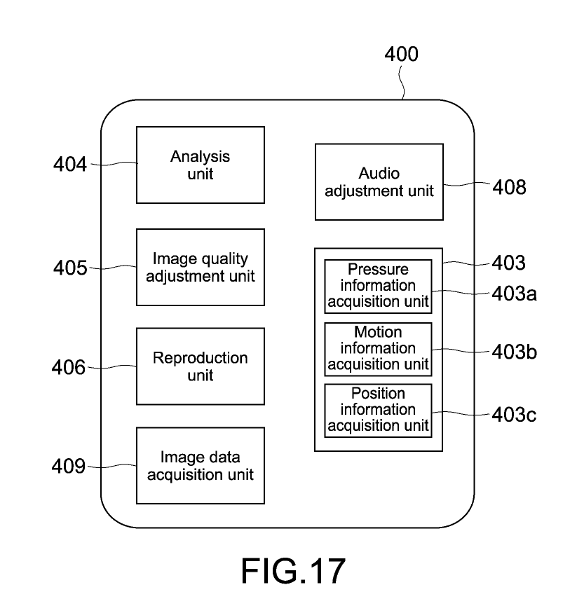

As shown in a block diagram of FIG. 17, an image processing apparatus 400 may include an audio adjustment unit 408 in addition to an image data acquisition unit 409, an information acquisition unit 403, an analysis unit 404, an image quality adjustment unit 405, and a reproduction unit 406. The audio adjustment unit 408 performs, based on the analyzed imaging situation, audio adjustment processing on the audio data recorded along with capturing the image as in the audio adjustment unit 308. With this, it is possible to adjust the output of the audio according to the imaging situation and enjoy the image data whose image quality has been adjusted as well as the audio suitable for the imaging situation.

### Other Modified Examples

Also in this embodiment, the analysis unit 404 may perform the analysis using the information from the information acquisition unit 403 as well as the information extracted by analyzing the feature of the subject in the image data described in Modified Example 1-1 and the information extracted from the audio data during imaging described in Modified Example 1-2. With this, it is possible to enhance the analysis accuracy of the imaging situation of the analysis unit 404.

### Fifth Embodiment

As in the following embodiment, the image processing system may be configured as a cloud system.

[Hardware Configuration of Image Processing System]

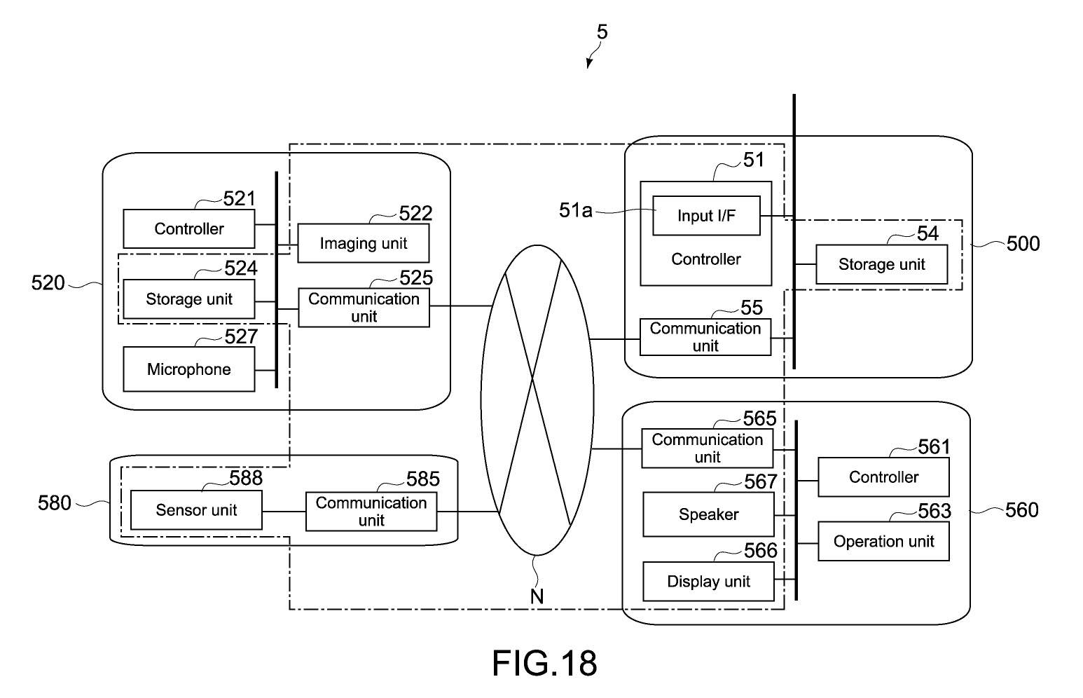

FIG. 18 is a block diagram showing a hardware configuration of an image processing system 5 according to a fifth embodiment of the present technology. The image processing system 5 includes an image processing apparatus 500, an imaging apparatus 520, a sensor apparatus 580, and a reproduction apparatus 560. The image processing apparatus 500 and the respective apparatuses of the image processing system 5 are connected to one another via a network N. Note that, also in this embodiment, it is assumed that the image data is the moving image data.

The image processing system 5 is configured such that the image processing apparatus 500 can perform image processing on image data captured by the imaging apparatus 520 using information detected during imaging and this image data can be reproduced by the reproduction apparatus 560. Part of the processing of the image processing system 5 may be performed based on an operation of the user with respect to the reproduction apparatus 560. Note that the image processing system 5 may include a plurality of imaging apparatuses 520, a plurality of sensor apparatuses 580, and a plurality of reproduction apparatuses 560. This enables a plurality of users to share the image processing apparatus 500.

The imaging apparatus 520 is configured to be capable of capturing image data. The imaging apparatus 520 includes a controller 521, an imaging unit 522, a storage unit 524, a communication unit 525, and a microphone 527. The respective units of the controller 521, the imaging unit 522, the storage unit 524, the communication unit 525, and the microphone 527 are connected to one another via a bus and configured to be capable of transferring data and transmitting and receiving a control signal. Note that the imaging apparatus 520 may include, in addition to the above-mentioned components, a display unit, a speaker, a sensor unit, and an operation unit (not shown). The imaging apparatus 520 may be an imaging apparatus capable of capturing a moving image or may be a portable information terminal such as a smart phone and a tablet terminal. As in the image processing apparatus 100, the imaging apparatus 520 may be worn by the user or may be adapted for onboard imaging or imaging in water.

The controller 521 includes a CPU and comprehensively controls the respective units of the imaging apparatus 520. The imaging unit 522 obtains image data from an optical image of a subject. The storage unit 524 is configured by, for example, a semiconductor memory, recoding media, and a recording and reproducing mechanism for the recoding media and configured to be capable of storing image data captured by the imaging unit 522. The communication unit 525 is configured to be communicable with the network N and capable of transmitting the image data stored in the storage unit 524 to the image processing apparatus 500 via the network N. The microphone 527 is configured to be capable of receiving the audio data.

Each of the sensor apparatuses 580 is configured to be capable of detecting information based on the activity performed along with capturing the image. The sensor apparatus 580 may be configured to be wearable by the user who takes an image or the subject. Alternatively, the imaging apparatus 520 may be configured to be attachable to a bicycle, an automobile, or the like driven by the user or the subject. With this, the sensor apparatus 580 is capable of detecting a sensor value based on the activity of at least either one of the user and the subject during capturing the image. Further, the image processing system 5 includes the plurality of sensor apparatuses 580, and hence the image processing apparatus 500 is capable of detecting the information based on the activities of both of the user and the subject.

The sensor apparatus 580 includes a communication unit 585 and a sensor unit 588. Note that the sensor apparatus 580 may include, in addition to the above-mentioned components, a display unit, a speaker, a storage unit, an operation unit, and a controller (not shown).

The sensor unit 588 includes an acceleration sensor, a pressure sensor, an angular velocity sensor, a geomagnetic sensor, and the like. By receiving a signal from a GPS, the communication unit 585 is configured to be capable of acquiring latitude/longitude information and also capable of transmitting information detected by the sensor unit 588 to the image processing apparatus 500 via the network. Note that the communication unit 585 may be configured to be wiredly or wirelessly connectable to the imaging apparatus 520.

The image processing apparatus 500 includes a controller 51, a storage unit 54, and a communication unit 55. The respective units of the controller 51, the storage unit 54, and the communication unit 55 are connected to one another via a bus and configured to be capable of transferring data and transmitting and receiving a control signal. The image processing apparatus 500 can be configured by, for example, a server apparatus (information processing apparatus) over the network N.

A schematic configuration of the controller 51, the storage unit 54, and the communication unit 55 is the same as that of the controller 11, the storage unit 14, and the communication unit 15, and hence will be simplified and described hereinafter. Note that the image processing apparatus 500 may include a display unit, an audio device unit, and an operation unit (not shown).

The controller 51 includes a CPU and comprehensively controls the respective units of the image processing apparatus 500. The controller 51 performs predetermined processing according to a control program stored in a ROM (not shown) or the storage unit 54. Note that the controller 51 includes an input I/F 51a into which information input from the imaging apparatus 520 and the sensor apparatus 580 which will be described later through the communication unit 55 is input.

The storage unit 54 can be configured by, for example, a semiconductor memory such as a flash memory, recoding media such as a magnetic disc, an optical disc, and a magneto-optical disk, and a recording and reproducing mechanism for the recoding media.

The communication unit 55 is configured to be communicable with the network N through a communication system such as a wired LAN, a wireless LAN, an LTE, and a 3G. With this, the communication unit 55 can be connected to the imaging apparatus 520, the sensor apparatus 580, and the reproduction apparatus 560. Note that the communication unit 45 may be configured to be connectable to a peripheral device via an external bus or the like of predetermined standards or may include another communication system.

The reproduction apparatus 560 is configured to be capable of reproducing the image data. The reproduction apparatus 560 includes a controller 561, an operation unit 563, a communication unit 565, a display unit 566, and a speaker 567. The respective units of the controller 561, the operation unit 563, the communication unit 565, the display unit 566, and the speaker 567 are connected to one another via a bus and configured to be capable of transferring data and transmitting and receiving a control signal. Note that the reproduction apparatus 560 may include, in addition to the above-mentioned components, a storage unit, a microphone, and a sensor unit (not shown).

The reproduction apparatus 560 may be an information processing apparatus such as a PC, a smart phone, and a tablet terminal.

In the image processing system 5 having the configuration as described above, the imaging unit 522, the storage unit 524, and the communication unit 525 of the imaging apparatus 520, the sensor unit 588 and the communication unit 585 of the sensor apparatus 580, the controller 51, the storage unit 54, and the communication unit 55 of the image processing apparatus 500, and the communication unit 565, the display unit 566, and the speaker 567 of the reproduction apparatus 560 that are shown in the alternate long and short dash line of FIG. 18 have a functional configuration as follows.

[Functional Configuration of Image Processing System]

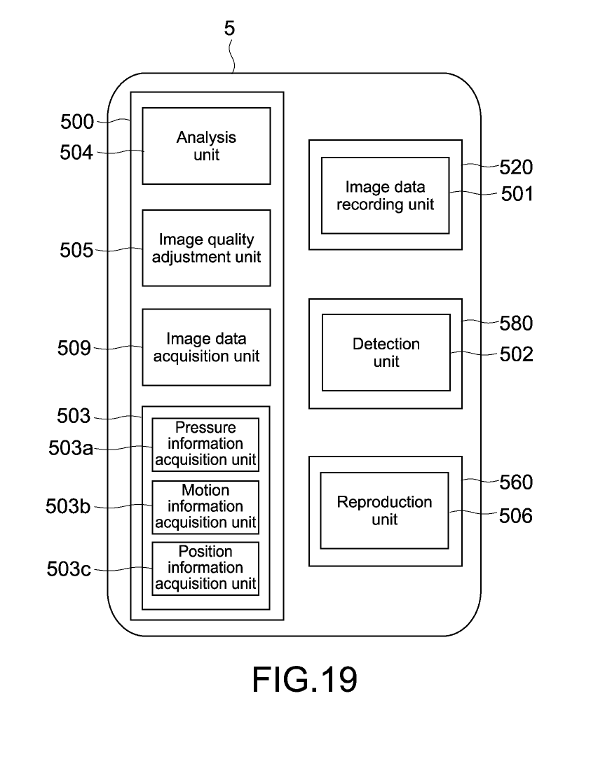

FIG. 19 is a block diagram showing a functional configuration of the image processing system 5.

As shown in the figure, the image processing system 5 includes an image data recording unit 501, a detection unit 502, an information acquisition unit 503, an analysis unit 504, an image quality adjustment unit 505, a reproduction unit 506, and an image data acquisition unit 509. Among them, the image processing apparatus 500 includes an information acquisition unit 503, an analysis unit 504, an image quality adjustment unit 505, and an image data acquisition unit 509. The imaging apparatus 520 includes an image data recording unit 501. The sensor apparatus 580 includes a detection unit 502. The reproduction apparatus 560 includes a reproduction unit 506.

The image data recording unit 501 captures an image, records the image as image data, and transmits the image data in response to a request of the image data acquisition unit 509. The image data recording unit 501 is realized by, for example, the storage unit 524 and the communication unit 525 of the imaging apparatus 520.

The detection unit 502 detects information based on the activity of the user during capturing the image and transmits the information in response to a request of the information acquisition unit 503. The detection unit 502 is realized by, for example, the sensor unit 588 and the communication unit 585 of the sensor apparatus 580. The detection unit 502 is configured to be capable of detecting a pressure value received during imaging of the user, motion information during imaging of the user, and position information during imaging of the user.

The information acquisition unit 503 acquires detected information based on the activity of at least either one of the user and the subject during capturing the image. The information acquisition unit 503 is capable of acquiring at least any of the pressure value, the motion information, and the position information based on the activity performed along with capturing the image. That is, the information acquisition unit 503 includes a pressure information acquisition unit 503a, a motion information acquisition unit 503b, and a position information acquisition unit 503c. The pressure information acquisition unit 503a acquires a pressure value received during imaging of at least either one of the user and the subject. The motion information acquisition unit 503b acquires motion information during imaging of at least either one of the user and the subject, i.e., information on acceleration, angular velocity, and the like. The position information acquisition unit 503c acquires position information during imaging of at least either one of the user and the subject. The information acquisition unit 503 is realized by, for example, the input I/F 51a of the controller 51 of the image processing apparatus 500.

The analysis unit 504 analyzes, as in the analysis unit 104, the imaging situation of image based on the information acquired by the information acquisition unit 503. The analysis unit 504 is realized by the controller 51 of the image processing apparatus 500, for example.

The image quality adjustment unit 505 performs, based on the analyzed imaging situation, the image quality adjustment processing on the image data corresponding to the imaging situation as in the image quality adjustment unit 105. The image quality adjustment unit 505 is realized by, for example, the controller 51. A correspondence relationship between the image quality adjustment processing and the imaging situation is stored in the storage unit 54.

The reproduction unit 506 reproduces the image data whose image quality has been adjusted as in the reproduction unit 106. The reproduction unit 506 may also reproduce the audio data acquired during capturing the image. The reproduction unit 506 is realized by, for example, the display unit 566 and the speaker 567 of the reproduction apparatus 560.

The image data acquisition unit 509 acquires the image data corresponding to the imaging situation. The image data acquisition unit 509 is realized by, for example, the controller 51 and the communication unit 55 of the image processing apparatus 500. The image data acquisition unit 509 may be configured to be capable of also acquiring the audio data recorded during capturing the image.

The image data acquisition unit 509 may be capable of matching the information acquired by the information acquisition unit 503 with the image data acquired via the network N. For example, the image data acquisition unit 509 may extract points of time from metadata of the image data and the information acquired by the information acquisition unit 503 and match them with each other. Alternatively, if the information acquired by the information acquisition unit 503 is, for example, tagged indicating a correspondence to the image data, the image data acquisition unit 509 may perform matching using this tag or may perform matching in another way.

[Operation Example of Image Processing System]

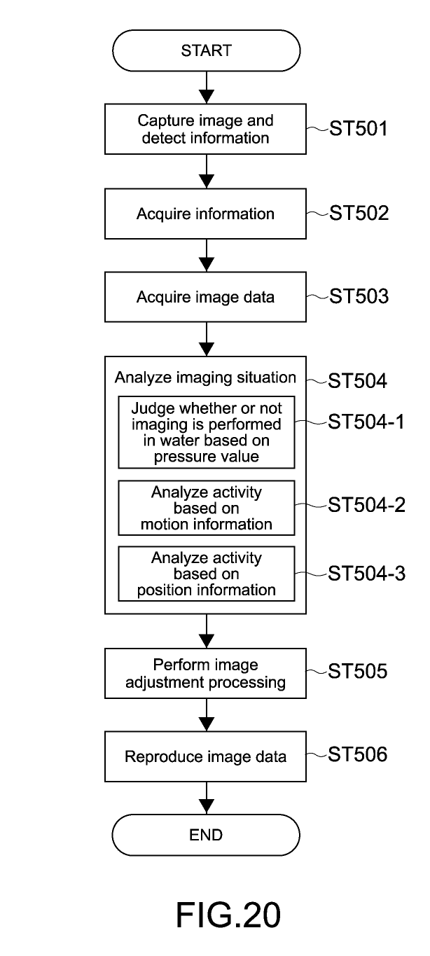

FIG. 20 is a flowchart showing an operation of the image processing system 5.

First, the imaging apparatus 420 captures the moving image and at the same time the detection unit 502 of the sensor apparatus 580 detects information based on an activity of either one of the user and the subject during capturing a moving image (image) (ST501). Then, the information acquisition unit 503 of the image processing apparatus 500 requests the detection unit 502 to transmit detected information to thereby acquire this information (ST502). The transmission request may be performed based on an input operation of the user with respect to the reproduction apparatus 560. The information acquisition unit 503 can acquire, for example, a pressure value, motion information, position information, and the like.

Then, the image data acquisition unit 509 of the image processing apparatus 500 requests the image data recording unit 501 to transmit the moving image data to thereby acquire the moving image data (ST503). Alternatively, the image data acquisition unit 509 may acquire the moving image data store in a moving image database or the like over the network N. The transmission request may be performed based on an input operation of the user with respect to the reproduction apparatus 560. The image data acquisition unit 509 can match the acquired moving image data with the detected information.

Next, based on the information acquired by the information acquisition unit 503 of the image processing apparatus 500, the analysis unit 504 analyzes the imaging situation of the moving image (ST504). The analysis unit 504 may judge, based on, for example, the pressure value, whether or not the imaging is performed in water (ST504-1) or may analyze, based on the motion information, the activity performed along with capturing the moving image (ST504-2). Alternatively, the analysis unit 504 may analyze, based on the position information, the activity performed along with capturing the moving image (ST504-3).

Next, as in ST104 of FIG. 3, the image quality adjustment unit 505 performs, based on the analyzed imaging situation, the image quality adjustment processing on the moving image data corresponding to the imaging situation (ST505).

Finally, the reproduction unit 506 of the reproduction apparatus 560 reproduces the moving image (image) data whose image quality has been adjusted (ST506).

Also the image processing apparatus 500 having the above-mentioned configuration is capable of performing processing as in the image processing apparatus 100. That is, also in this embodiment, the imaging situation is analyzed based on the motion information, the position information, and the like detected based on the activity performed along with capturing the moving image. It becomes possible to automatically perform, based on this imaging situation, the image quality adjustment on the moving image data.

In addition, according to this embodiment, it becomes possible to adjust the image quality based on the imaging situation, utilizing a cloud system. With this, it becomes possible to enjoy services using the image processing apparatus 500 through a user terminal such as the reproduction apparatus 560.

### Modified Example 5-1

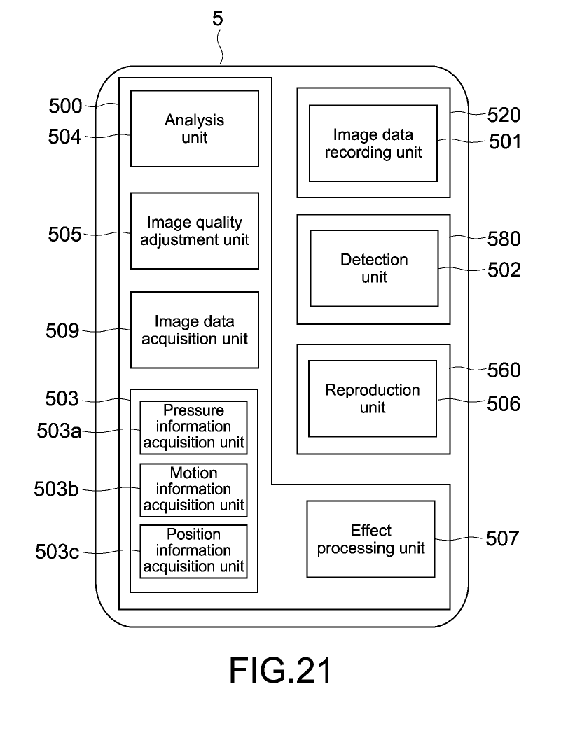

As shown in a block diagram of FIG. 21, the image processing apparatus 500 may include an effect processing unit 507 in addition to an image data acquisition unit 509, an information acquisition unit 503, an analysis unit 504, an image quality adjustment unit 505, and a reproduction unit 506. As in the effect processing unit 207, the effect processing unit 507 performs, based on analyzed imaging situation, effect processing on image data corresponding to an imaging situation. With this, based on the imaging situation of the image, it is possible to perform not only the image quality adjustment but also the effect processing of the image data. Therefore, it is possible to easily reproduce the image data from which it is easy to understand the imaging situation and which can enhance the sense of presence during imaging.

### Modified Example 5-2

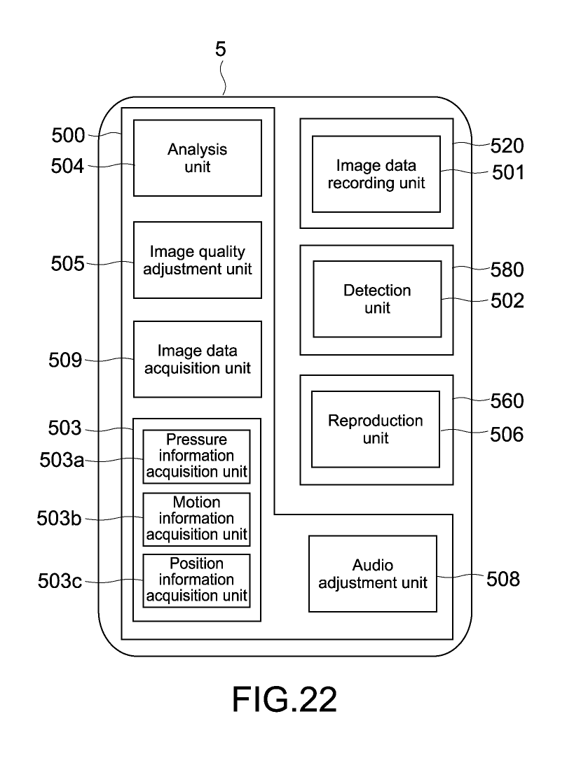

As shown in a block diagram of FIG. 22, the image processing apparatus 500 may include an audio adjustment unit 508 in addition to an image data acquisition unit 509, an information acquisition unit 503, an analysis unit 504, an image quality adjustment unit 505, and a reproduction unit 506. As in the audio adjustment unit 508, the audio adjustment unit 508 performs, based on analyzed imaging situation, audio adjustment processing on audio data recorded along with capturing an image. With this, it is possible to adjust the output of the audio according to the imaging situation and enjoy the image data whose image quality has been adjusted as well as the audio suitable for the imaging situation.

### Other Modified Examples

Also in this embodiment, the analysis unit 504 may perform analysis using the information from the information acquisition unit 503 as well as the information extracted by analyzing the feature of the subject in the image data described in Modified Example 1-1 and the information extracted from the audio data during imaging described in Modified Example 1-2. With this, it is possible to enhance the analysis accuracy of the imaging situation of the analysis unit 504.

Although the embodiments of the present technology have been described, the present technology is not limited only to the above-mentioned embodiments and various modifications can be made without departing from the present technology.

For example, in the above-mentioned embodiments, the image data is the moving image data. However, the image data may be a still image data. In this case, the information acquisition unit acquires information detected based on an activity performed along with capturing the still image. For example, the information acquisition unit can acquire a pressure value, motion information, position information, and the like that are detected within a predetermined period of time including a point of time when the still image is captured. The analysis unit analyzes an imaging situation of the still image data based on this information. Then, the image quality adjustment unit performs, based on the analyzed imaging situation, the image quality adjustment processing on the still image data corresponding to the imaging situation.

With this, even in the case of the still image, it is possible to adjust the image quality based on the imaging situation thereof and to reproduce the still image data whose deterioration in image quality estimated based on the imaging situation has been reduced or the still image data more suitable for the imaging situation.

Further, the audio adjustment processing unit is capable of performing, based on the analyzed imaging situation, audio adjustment processing on audio data recorded within a predetermined period of time including the point of time when the still image is captured. With this, it is possible to perform audio adjustment processing suitable for the imaging situation on the audio data that can be reproduced together with the still image.

For example, in the above-mentioned embodiments, as the information acquired by the information acquisition unit, the pressure value, the motion information, and the position information are exemplified. However, the information acquired by the information acquisition unit is not limited thereto.

The image processing apparatus is not limited to the example in which it is configured by a single apparatus. The image processing apparatus may be configured by a plurality of apparatuses such as a server apparatus in a network (information processing apparatus) and an information processing apparatus serving as a user terminal. In this case, the information acquisition unit and the analysis unit may be realized by a controller of the server apparatus and the image quality adjustment unit may be realized by a controller of the user terminal. Also with this, the image processing apparatus having the above-mentioned action and effect can be realized.

Note that the present technology may take also configurations as described above.

(1) An image processing apparatus, including:

an information acquisition unit configured to acquire information detected based on an activity performed along with capturing an image;

an analysis unit configured to analyze an imaging situation of the image based on the information; and

an image quality adjustment unit configured to perform, based on the analyzed imaging situation, image quality adjustment processing on image data corresponding to the imaging situation.

(2) The image processing apparatus according to (1), in which

the image quality adjustment processing is processing of reducing deterioration in image quality estimated based on the analyzed imaging situation.

(3) The image processing apparatus according to (1) or (2), in which

the information acquisition unit is configured to acquire information detected based on an activity of a user during capturing an image.

(4) The image processing apparatus according to any one of (1) to (3), in which

the information acquisition unit is configured to acquire at least any of a pressure value, motion information, and position information based on an activity performed along with capturing an image.

(5) The image processing apparatus according to (4), in which

the information acquisition unit includes a pressure information acquisition unit configured to acquire a pressure value received during imaging of at least either one of the user and a subject, and

the analysis unit is configured to judge, based on the pressure value, whether or not imaging is performed in water.

(6) The image processing apparatus according to (4) or (5), in which

the information acquisition unit includes a motion information acquisition unit configured to acquire motion information of at least either one of the user and a subject, and

the analysis unit is configured to analyze, based on the motion information, the activity performed along with capturing the image.

(7) The image processing apparatus according to (6), in which

the motion information acquisition unit is configured to acquire a frequency of vibration as the motion information,

the analysis unit is configured to conclude, if the frequency of the vibration is equal to or higher than a predetermined frequency, that the activity is an imaging situation with vibration, and

the image quality adjustment unit is configured to perform processing of correcting vibration of the image data based on the frequency of the vibration, if it is concluded that the activity is the imaging situation with vibration.

(8) The image processing apparatus according to any one of (4) to (7), in which

the information acquisition unit includes a position information acquisition unit configured to acquire position information during imaging of at least either one of the user and a subject, and

the analysis unit is configured to analyze, based on the position information, the activity performed along with capturing the image.

(9) The image processing apparatus according to any one of (1) to (8), in which

the analysis unit is configured to analyze the imaging situation of the image based on the information acquired by the information acquisition unit and information extracted by analyzing a feature of a subject in the image.

(10) The image processing apparatus according to any one of (1) to (9), further including

an effect processing unit configured to perform, based on the analyzed imaging situation, effect processing on the image data corresponding to the imaging situation.

(11) The image processing apparatus according to any one of (1) to (10), further including

an audio adjustment unit configured to perform, based on the analyzed imaging situation, audio adjustment processing on audio data recorded along with capturing the image.

(12) The image processing apparatus according to any one of (1) to (11), further including

an image data recording unit configured to capture an image and record the image as image data.

(13) The image processing apparatus according to any one of (1) to (12), further including

a reproduction unit configured to reproduce the image data.

(14) The image processing apparatus according to any one of (1) to (13), further including

an image data acquisition unit configured to acquire the image data corresponding to the imaging situation.

(15) An image processing method, including:

acquiring information detected based on an activity performed along with capturing an image;

analyzing an imaging situation of the image based on the information; and

performing, based on the analyzed imaging situation, image quality adjustment processing on image data corresponding to the imaging situation.

(16) A program that causes an information processing apparatus to function as:

an information acquisition unit configured to acquire information detected based on an activity performed along with capturing an image;

an analysis unit configured to analyze an imaging situation of the image based on the information; and

an image quality adjustment unit configured to perform, based on the analyzed imaging situation, image quality adjustment processing on image data corresponding to the imaging situation.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
an information acquisition unit configured to acquire information detected based on an activity performed along with capturing an image;
an analysis unit configured to analyze an imaging situation of the image based on the information; and
an image quality adjustment unit configured to perform, based on the analyzed imaging situation, image quality adjustment processing on image data corresponding to the imaging situation.

2. The image processing apparatus according to claim 1, wherein
the image quality adjustment processing is processing of reducing deterioration in image quality estimated based on the analyzed imaging situation.

3. The image processing apparatus according to claim 1, wherein
the information acquisition unit is configured to acquire information detected based on an activity of a user during capturing an image.

4. The image processing apparatus according to claim 1, wherein
the information acquisition unit is configured to acquire at least any of a pressure value, motion information, and position information based on an activity performed along with capturing an image.

5. The image processing apparatus according to claim 4, wherein
the information acquisition unit includes a pressure information acquisition unit configured to acquire a pressure value received during imaging of at least either one of the user and a subject, and
the analysis unit is configured to judge, based on the pressure value, whether or not imaging is performed in water.

6. The image processing apparatus according to claim 4, wherein
the information acquisition unit includes a motion information acquisition unit configured to acquire motion information of at least either one of the user and a subject, and
the analysis unit is configured to analyze, based on the motion information, the activity performed along with capturing the image.

7. The image processing apparatus according to claim 6, wherein
the motion information acquisition unit is configured to acquire a frequency of vibration as the motion information,
the analysis unit is configured to conclude, if the frequency of the vibration is equal to or higher than a predetermined frequency, that the activity is an imaging situation with vibration, and
the image quality adjustment unit is configured to perform processing of correcting vibration of the image data based on the frequency of the vibration, if it is concluded that the activity is the imaging situation with vibration.

8. The image processing apparatus according to claim 4, wherein
the information acquisition unit includes a position information acquisition unit configured to acquire position information during imaging of at least either one of the user and a subject, and
the analysis unit is configured to analyze, based on the position information, the activity performed along with capturing the image.

9. The image processing apparatus according to claim 1, wherein
the analysis unit is configured to analyze the imaging situation of the image based on the information acquired by the information acquisition unit and information extracted by analyzing a feature of a subject in the image.

10. The image processing apparatus according to claim 1, further comprising
an effect processing unit configured to perform, based on the analyzed imaging situation, effect processing on the image data corresponding to the imaging situation.

11. The image processing apparatus according to claim 1, further comprising
an audio adjustment unit configured to perform, based on the analyzed imaging situation, audio adjustment processing on audio data recorded along with capturing the image.

12. The image processing apparatus according to claim 1, further comprising
an image data recording unit configured to capture an image and record the image as image data.

13. The image processing apparatus according to claim 1, further comprising
a reproduction unit configured to reproduce the image data.

14. The image processing apparatus according to claim 1, further comprising
an image data acquisition unit configured to acquire the image data corresponding to the imaging situation.

15. An image processing method, comprising:
acquiring information detected based on an activity performed along with capturing an image;
analyzing an imaging situation of the image based on the information; and
performing, based on the analyzed imaging situation, image quality adjustment processing on image data corresponding to the imaging situation.

16. A program that causes an information processing apparatus to function as:
an information acquisition unit configured to acquire information detected based on an activity performed along with capturing an image;
an analysis unit configured to analyze an imaging situation of the image based on the information; and
an image quality adjustment unit configured to perform, based on the analyzed imaging situation, image quality adjustment processing on image data corresponding to the imaging situation.
